(19) United States
(12) Patent Application Publication
(10) Pub. No.: US 2014/0206209 A1
(43) Pub. Date: Jul. 24, 2014

(54) REVERSIBLE USB CONNECTOR

(71) Applicant: Apple Inc., Cupertino, CA (US)

(72) Inventors: Ibuki Kamei, San Jose, CA (US); Warren Z. Jones, San Jose, CA (US); Eric S. Jol, San Jose, CA (US); Albert J. Golko, Saratoga, CA (US); Eric T. SooHoo, Sunnyvale, CA (US)

(73) Assignee: Apple Inc., Cupertino, CA (US)

(21) Appl. No.: 14/160,528

(22) Filed: Jan. 21, 2014

Related U.S. Application Data
(60) Provisional application No. 61/756,413, filed on Jan. 24, 2013.
(60) Provisional application No. 61/765,602, filed on Feb. 15, 2013.

(51) Int. Cl. H01R 13/64; H01R 12/81

(52) U.S. Cl. CPC H01R 13/64; H01R 12/81
USPC 439/81; 439/884

(57) ABSTRACT

Embodiments can provide reversible or dual orientation USB plug connectors for mating with standard USB receptacle connectors, e.g., a standard Type A USB receptacle connector. Accordingly, the present invention may be compatible with any current or future electronic device that includes a standard USB receptacle connector. USB plug connectors according to the present invention can have a 180 degree symmetrical, double orientation design, which enables the plug connector to be inserted into a corresponding receptacle connector in either of two intuitive orientations. Some embodiments of the present invention may be used with or require a non-standard USB receptacle connector. Thus, embodiments of the present invention may reduce the potential for USB connector damage and user frustration during the incorrect insertion of a USB plug connector into a corresponding USB receptacle connector of an electronic device.

### CROSS-REFERENCES TO RELATED APPLICATIONS

This application claims benefit of U.S. Provisional Application No. 61/756,413, filed Jan. 24, 2013, and U.S. Provisional Application 61/765,602, filed Feb. 15, 2013, which are incorporated herein by reference for all purposes.

### BACKGROUND OF THE INVENTION

The present invention relates generally to input/output electrical connectors such as data connectors.

Many electronic devices include data connectors, such as Universal Serial Bus (USB) connectors, that receive and provide power and data. These electrical connectors are typically female receptacle connectors and are designed to receive a male plug connector. The plug connector may be on the end of a cable and plug into an electronic device, thereby forming one or more conductive paths for signals and power.

USB connectors, like many other standard data connectors, require that male plug connectors be mated with corresponding female receptacle connectors in a single, specific orientation in order for the USB connection to function properly. Such connectors can be referred to as polarized connectors. Accordingly, USB receptacle connectors include an insertion opening with features that prevents USB plug connectors from being inserted into the USB receptacle connector in the wrong way. That is, it can only be inserted one way because it is a polarized connector. Many other commonly used data connectors, including mini USB connectors, FireWire connectors, as well as many other proprietary connectors are also polarized connectors.

It is sometimes difficult for users to determine when a polarized plug connector, such as a USB plug connector, is oriented in the correct orientation for insertion into a corresponding receptacle connector. Some USB plug and/or receptacle connectors may include markings to indicate their orientation such that users know how to properly insert a plug connector into corresponding receptacle connectors. However, these marking are not always utilized by users and/or can be confusing to some users. In some cases, these markings are not helpful because the markings cannot be easily viewed due to the location of the receptacle connector, lighting conditions, or other reasons. Even when visible, these markings may still be unhelpful because not all manufacturers apply these markings in a consistent fashion. Consequently, users may incorrectly insert a plug connector into a corresponding receptacle connector, which may potentially result in damage to the connectors and/or user frustration.

Accordingly, it is desirable to provide connectors, e.g., USB connectors, that do not suffer from all or some of these deficiencies.

### BRIEF DESCRIPTION OF THE DRAWINGS

To better understand the nature and advantages of the present invention, reference should be made to the following description and the accompanying figures. It is to be understood, however, that each of the figures is provided for the purpose of illustration only and is not intended as a definition of the limits of the scope of the present invention. Also, as a general rule, and unless it is evident to the contrary from the description, where elements in different figures use identical reference numbers, the elements are generally either identical or at least similar in function or purpose.

FIGS. 1A and 1B are partial cross sectional perspective and cross sectional views, respectively, of a USB plug connector according to one embodiment of the present invention;

FIGS. 2A and 2B are simplified perspective and cross sectional views, respectively, of a USB plug connector 110 in various stages of manufacture according to one embodiment of the present invention;

FIGS. 3A and 3B are simplified perspective and cross sectional views, respectively, of a USB plug connector 210 in various stages of manufacture according to another embodiment of the present invention;

FIGS. 4A and 4B are simplified perspective and cross sectional views, respectively, of a USB plug connector 310 in various stages of manufacture according to yet another embodiment of the present invention;

FIGS. 5A and 5B are simplified perspective and cross sectional views, respectively, of a USB plug connector 410 in various stages of manufacture according to still another embodiment of the present invention;

FIGS. 6A and 6B are simplified perspective and cross sectional views, respectively, of a USB plug connector 510 in various stages of manufacture according to still another embodiment of the present invention;

FIGS. 7A and 7B are simplified perspective and cross sectional views, respectively, of a USB plug connector 610 in various stages of manufacture according to still another embodiment of the present invention;

FIGS. 8A and 8B are simplified perspective and cross sectional views, respectively, of a USB plug connector 710 in various stages of manufacture according to still another embodiment of the present invention;

FIGS. 9A and 9B are simplified perspective and cross sectional views, respectively, of a USB plug connector 810 in various stages of manufacture according to still another embodiment of the present invention;

FIGS. 10A and 10B are simplified perspective and cross sectional views, respectively, of a USB plug connector 910 in various stages of manufacture according to still another embodiment of the present invention;

FIGS. 11A and 11B are simplified perspective and cross sectional views, respectively, of a USB plug connector 1100 according to one embodiment of the present invention;

FIGS. 12A and 12B are partial cross sectional perspective and cross sectional views, respectively, of a USB plug connector 1210 according to one embodiment of the present invention;

FIGS. 13A and 13B are partial cross sectional perspective and cross sectional views, respectively, of a USB plug connector 1310 according to one embodiment of the present invention;

FIGS. 14A and 14B are partial cross sectional perspective and cross sectional views, respectively, of a USB plug connector 1410 according to one embodiment of the present invention;

FIGS. 15A and 15B are partially transparent simplified perspective and partially transparent front views, respectively, of a USB plug connector 1510 according to one particular embodiment of connector 1110;

FIGS. 15C-15F are top views of contact frames 1596a; 1596a and 1596b; 1596a, 1596b and 1596c; and 1596a, 1596b, 1596c and 1596d; respectively, in their positions with respect to each other when embedded in tab 1530;

FIGS. 16A and 16B are partial cross sectional perspective and cross sectional side views, respectively, of a USB plug connector 1610 according to one embodiment of the present invention;

FIGS. 16C and 16D are partial cross sectional, exploded perspective views of embodiments of structural support 1635 for assembling with and overmolding on tongue 1630 of plug connector 1610, respectively, according to manufacturing methods of the present invention;

FIGS. 17A and 17B are partial cross sectional perspective and cross sectional side views, respectively, of a USB plug connector 1710 according to one embodiment of the present invention;

FIG. 17C is an exploded view of contact frames 1798a-1798d of plug connector 1710;

FIGS. 18A and 18B are exploded and cross sectional side views, respectively, of a USB plug connector according to an embodiment of the present invention; and

FIGS. 18C-18H illustrate contact frames of the connector of FIGS. 18A and 18B in various stages of assembly according to an embodiment of the present invention.

### DETAILED DESCRIPTION OF THE INVENTION

The present invention will now be described in detail with reference to certain embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known details have not been described in detail in order not to unnecessarily obscure the present invention.

Embodiments can provide reversible or dual orientation USB plug connectors for mating with standard USB receptacle connectors, e.g., a standard Type A USB receptacle connector. Accordingly, the present invention may be compatible with any current or future electronic device that includes a standard USB receptacle connector. USB plug connectors according to the present invention can have a 180 degree symmetrical, dual or double orientation design which enables the plug connector to be inserted into a corresponding receptacle connector in either of two intuitive orientations. To allow for the orientation agnostic feature of such a plug connector, the portion of the plug connector having contacts may not be polarized. Instead, in some embodiments, the portion of the plug connector having contacts may be movable such that its contacts can mate with corresponding contacts of the receptacle connector in either of two intuitive orientations. Thus, embodiments of the present invention may reduce the potential for USB connector damage and user frustration during the insertion of the USB plug connector into a corresponding USB receptacle connector of an electronic device.

Methods for manufacturing plug connectors according to the present invention are also described below in relation to a specific plug connector embodiment. However, these methods of manufacture may apply to other plug connector embodiments described herein.

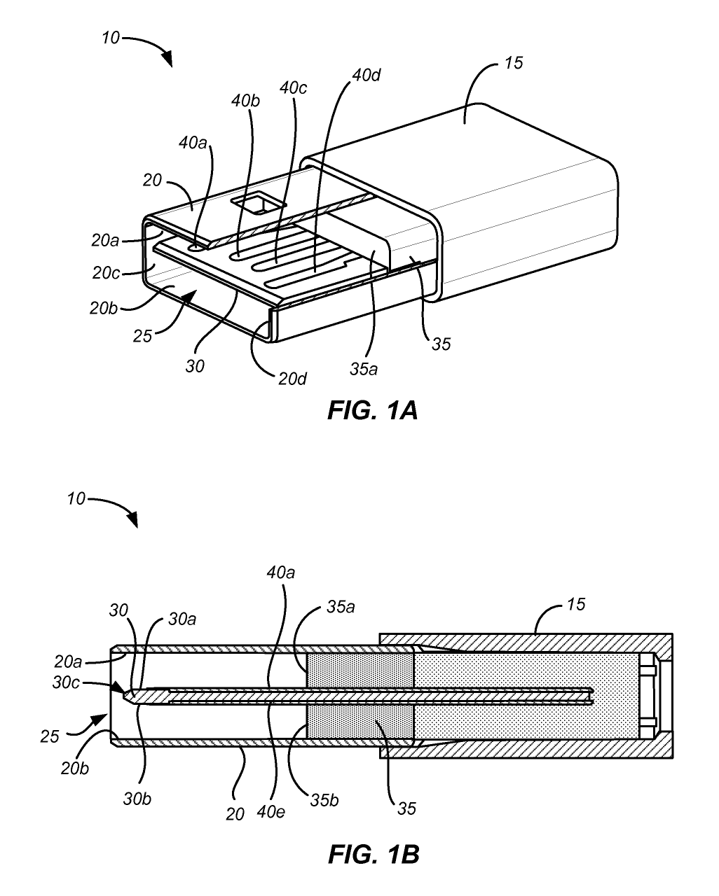

In order to better appreciate and understand the present invention, reference is first made to FIGS. 1A and 1B, which are partial cross sectional perspective and cross sectional views, respectively, of a USB plug connector 10 according to one embodiment of the present invention. Connector 10 includes a body 15 and a shell 20 extending longitudinally away from body 15 in a direction parallel to the length of connector 10. Shell 20 includes an opening 25 that communicates with a cavity defined by first, second, left and right inner surfaces 20a-20d of shell 20, a tongue 30, and first and second surfaces 35a, 35b of support structure 35. As shown in FIGS. 1A and 1B, tongue 30 may be centrally located between first and second inner surfaces 20a, 20b and extend parallel to the length of connector 10. Contacts 40a-40d are disposed on a first major surface 30a and four additional contacts (only contact 40e is shown in FIG. 1B) are disposed on second major surface 30b. As also shown in FIGS. 1A and 1B, tongue 30 may include a bullnose tip 30c for reasons that will be explained below.

As shown in FIGS. 1A and 1B, connector 10 can have a 180 degree symmetrical, double orientation design which enables the connector to be inserted into a corresponding receptacle connector in both a first orientation where surface 30a is facing up or a second orientation where surface 30a is rotated 180 degrees and facing down. To allow for the orientation agnostic feature of connector 10, tongue 30 is not polarized. That is, tongue 30 does not include a physical key that is configured to mate with a matching key in a corresponding receptacle connector designed to ensure that mating between the two connectors occurs only in a single orientation. Instead, if tongue 30 is divided into top and bottom halves along a horizontal plane that bisects the center of tongue 30 along its width, the physical shape of the upper half of tongue 30 is substantially the same as the physical shape of the lower half. Similarly, if tongue 30 is divided into left and right halves along a vertical plane that bisects the center of tab along its length, the physical shape of the left half of tongue 30 is substantially the same as the shape of the right half. Additionally, contacts 40a-40d and four additional contacts disposed on second major surface 30b can be positioned so that the contacts on first and second major surfaces 30a, 30b are arranged in a symmetric manner. Accordingly, the contacts disposed on first surface 30a (contacts 40a-40d) mate with contacts of the corresponding receptacle connector in one orientation and contacts disposed on second surface 30b mate with contacts of the corresponding receptacle connector in the other orientation.

Tongue 30 may be a printed circuit board (PCB) or may be made from one or more of a variety of dielectric materials including flexible, wear resistant materials such as liquid crystal polymers (LCP), polyoxymethylene (POM), Nylon and others. Structural support 35 may also be made from a variety of dielectric materials, including flexible polymers. The materials used to form tongue 30 and/or structural support 35 may be chosen such that tongue 30 deflects either toward first or second inner surfaces 20a, 20b of shell 20 when connector 10 is inserted into a corresponding receptacle connector. This deflection may occur as bullnose tip 30c comes into contact with internal features of a corresponding receptacle connector and leads tongue 30 to the appropriate region within a corresponding receptacle connector, allowing contacts disposed on either surface 30a or 30b of the plug connector 10 to mate with contacts on the corresponding receptacle connector.

As mentioned earlier, tongue 30 may be centrally located within opening 25 of shell 20. For example, tongue 30 may be positioned within opening 25 such that its distance from first and second inner surfaces 20a, 20b causes connector 10 to always deflect, with the assistance of bullnose tip 30c, toward the appropriate region within a corresponding receptacle connector regardless of whether plug connector 10 is in the first or second orientation, as described above. Portions of tongue 30 may deform and deflect in different manners in order to put its contact in position to mate with the contacts of the corresponding receptacle connector. The thickness of tongue 30 may be varied depending on the material of tongue 30 such that tongue 30 may elastically deform as necessary for mating events.

Body 15 is generally the portion of connector 10 that a user will hold onto when inserting or removing connector 10 from a corresponding receptacle connector. Body 15 can be made out of a variety of materials and in some embodiments is made from a dielectric material, such as a thermoplastic polymer formed in an injection molding process. While not shown in FIG. 1A or 1B, a cable and a portion of shell 20 may extend within and be enclosed by body 15. Also, electrical contact to the contacts of surfaces 30a, 30b can be made with individual wires in a cable within body 15. In one embodiment, a cable includes a plurality of individual insulated wires for connecting to contacts of surfaces 30a, 30b that are soldered to bonding pads on a PCB housed within body 15 or on tongue 30 when tongue 30 is a PCB. The bonding pads on the PCB may be electrically coupled to corresponding individual contacts of surfaces 30a and 30b. In some embodiments, contacts of one of surfaces 30a and 30b may be shorted through tongue 30 or a PCB to corresponding contacts on the other of surfaces 30a and 30b and then appropriately routed to the individual wires of a cable within body 15.

The contacts of tongue 30 can be made from copper, nickel, brass, a metal alloy or any other appropriate conductive material. In some embodiments, contacts can be printed on surfaces 30a and 30b using techniques similar to those used to print contacts on printed circuit boards. As with standard USB plug connectors, plug connector 10 may include contacts for power, ground and a pair of differential data signals (e.g., data transmit). For example, contact 40a may be a ground pin, contact 40b may be a Data+pin, contact 40c may be a Data−pin and contact 40d may be a power pin (VBUS). As mentioned earlier, the four additional contacts disposed on second major surface 30b can be positioned so that the contacts on first and second major surfaces 30a, 30b are arranged in a symmetric manner. Accordingly, pins may be designated for the contacts on the first and second major surfaces 30a, 30b such that the pinout may be the same for both surfaces 30a, 30b. For example, a contact 40e on surface 30b corresponding to (aligned with in the length and width directions of connector 10) contact 40a, may also be a power pin (VBUS), a contact on surface 30b corresponding to contact 40b may be a Data−pin, a contact on surface 30b corresponding to contact 40c may be a Data+pin and a contact on surface 30b corresponding to contact 40d may be a ground pin. In this manner, regardless of the orientation of plug connector 10, the same pinout may be mated with a corresponding receptacle connector during a mating event.

In some embodiments, a sensing circuit in the connector 10 can detect which of surfaces 30a and 30b of tongue 30 will mate with the contacts of the corresponding receptacle connector and switch internal connections to the contacts in connector 10 as appropriate. For example, a software switch can be used to switch the contacts of connector 10 for the pair of differential data signals depending on the insertion orientation while a hardware switch can be used to switch the ground and power contacts. In other embodiments, both switches can be implemented in software or both switches can be implemented in hardware. In another example, the orientation of the connector can instead be detected by circuitry of connector 10 based on signals received over the contacts. As one example, upon inserting connector 10 within a receptacle connector of a host device, connector 10 may send an Acknowledgment signal to the serial control chip over one of the contacts of connector 10 designated for the specific contact and waits for a Response signal from the host device. If a Response signal is received, the contacts are aligned properly and data and power can be transferred between the connectors. If no response is received, connector 10 flips the signals to correspond to the second possible orientation (i.e., flips the signals 180 degrees) and repeats the Acknowledgement/Response signal routine. As another example, the host device may send the Acknowledgement signal and connector 10 may send the Response signal.

It may be desirable to provide an effective manufacturing process for plug connectors discussed above as well variations thereof. Accordingly, embodiments of the present invention provide for methods of manufacture of reversible or dual orientation USB plug connectors. For example, inserting molding, assembling, and other methods may be used to manufacture plug connectors according to the present invention. Examples of these methods are illustrated in the following figures.

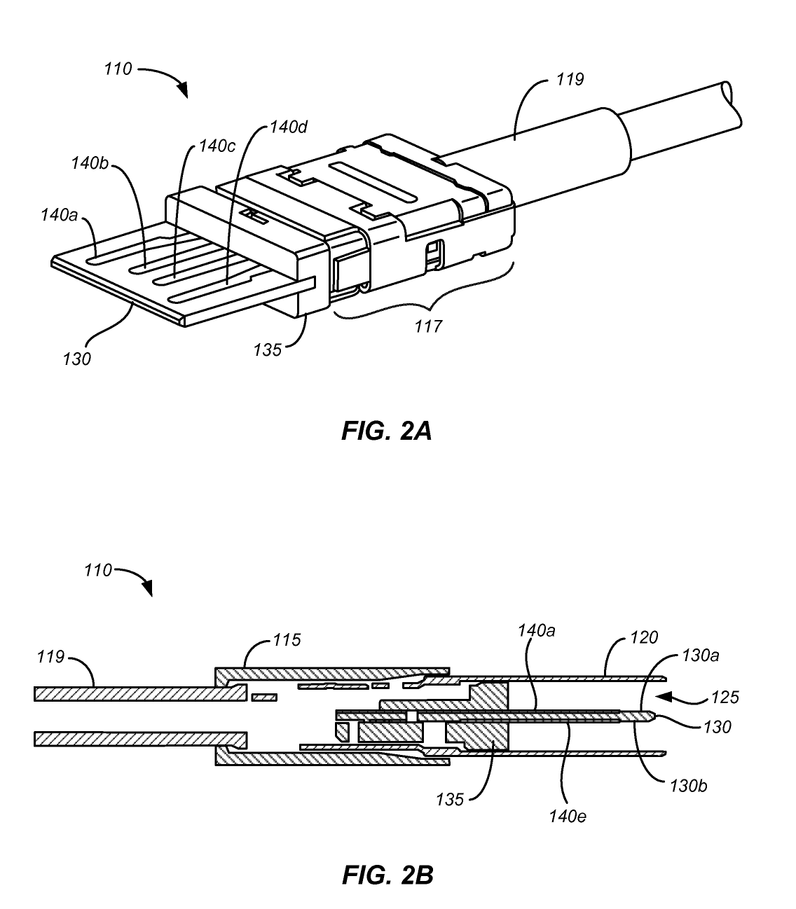

FIGS. 2A and 2B are simplified perspective and cross sectional views, respectively, of a USB plug connector 110 in various stages of manufacture according to one embodiment of the present invention. Plug connector 110 includes a base 115 (only shown in FIG. 2B) that may be attached over metallic shield 117 and cable 119. A shell 120 (only shown in FIG. 2B) may be assembled with base 115 and extend longitudinally away from body 15 in a direction parallel to the length of connector 110. Shell 120 includes an opening 125 that communicates with a cavity defined in part by tongue 130 and support structure 135 from which tongue 130 extends. As shown in FIGS. 2A and 2B, tongue 130 may be assembled with support structure 135 within shell 120 such that tongue 130 extends parallel to the length of connector 110. Contacts 140a-140d may be soldered on a first major surface 130a and four additional contacts (only contact 140e is shown in FIG. 2B) may be soldered on a second major surface 130b. Support structure 135 may also be overmolded in position to support and possibly provide increased deflection flexibility to tongue 130. In this embodiment, tongue 130 may be a PCB that deflects when connector 110 is mated with a corresponding plug connector.

In some embodiments, tongue 130 may be overmolded with a resilient polymer, e.g., LCP or POM, before or after it is assembled with support structure 135. In this embodiment, the contacts of plug connector 110 may be copper contacts that are thick enough to remain flush with the exterior surface of tongue 130 after tongue 130 has been overmolded with a resilient polymer.

The methods and structure described above in relation to FIGS. 2A and 2B may be varied in other embodiments. Examples of these variations are included in the following figures.

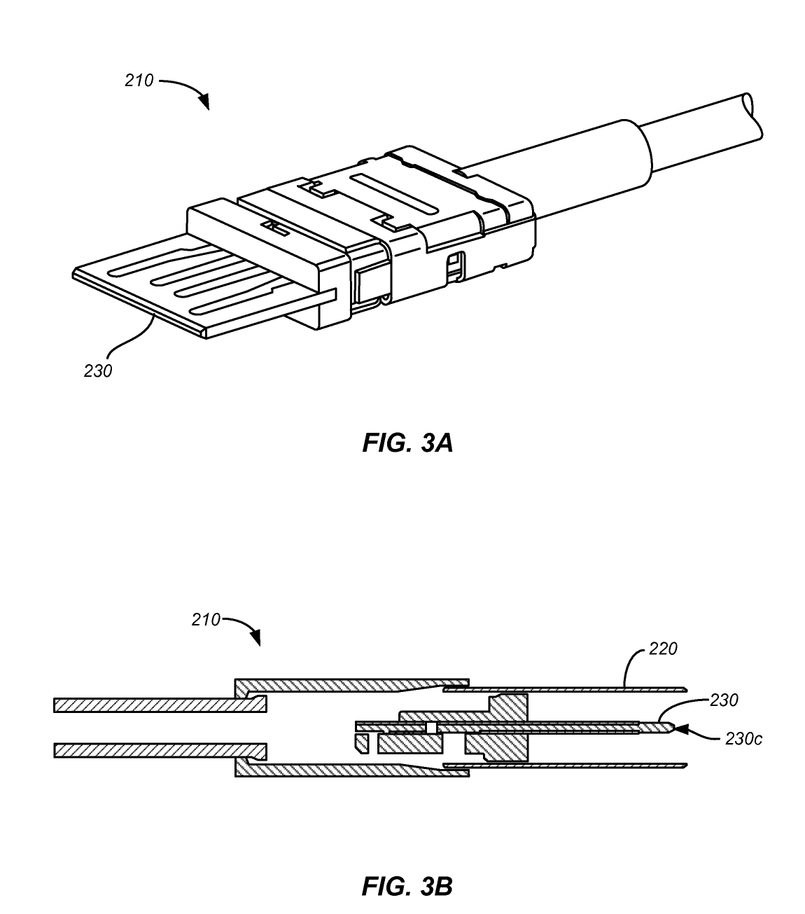

FIGS. 3A and 3B are simplified perspective and cross sectional views, respectively, of a USB plug connector 210 in various stages of manufacture according to another embodiment of the present invention. USB connector 210 is similar to USB connector 110 described above, except that an additional step of routing has been performed on tip 230c of tongue 230 such that tip 230 is bullnose shaped for reasons already discussed above.

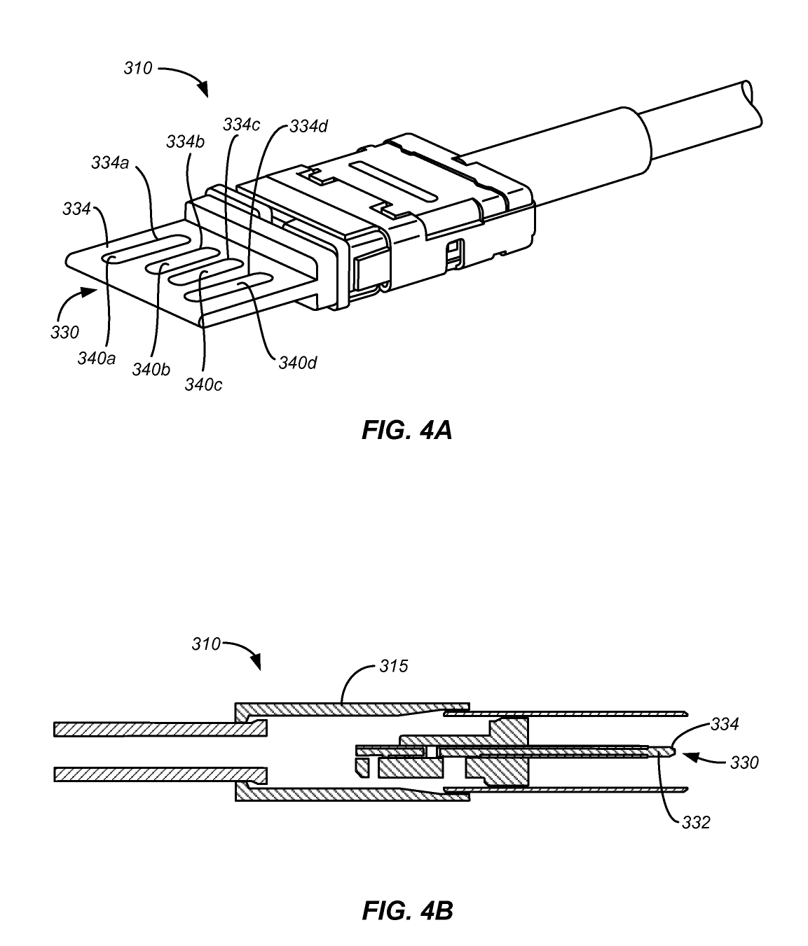

FIGS. 4A and 4B are simplified perspective and cross sectional views, respectively, of a USB plug connector 310 in various stages of manufacture according to yet another embodiment of the present invention. Connector 310 is similar to embodiments discussed above, e.g., plug connectors 110 and 210. However, although tongue 330 includes a PCB 332 like the other embodiments described above, tongue 330 also includes a sleeve 334 that may be assembled over PCB 332. As show in FIG. 4A, sleeve 334 may include openings 334a-334d and additional openings not shown such that all contacts of connector 310 (e.g., contacts 340a-340d) remain exposed and accessible by contacts of a corresponding USB receptacle connector.

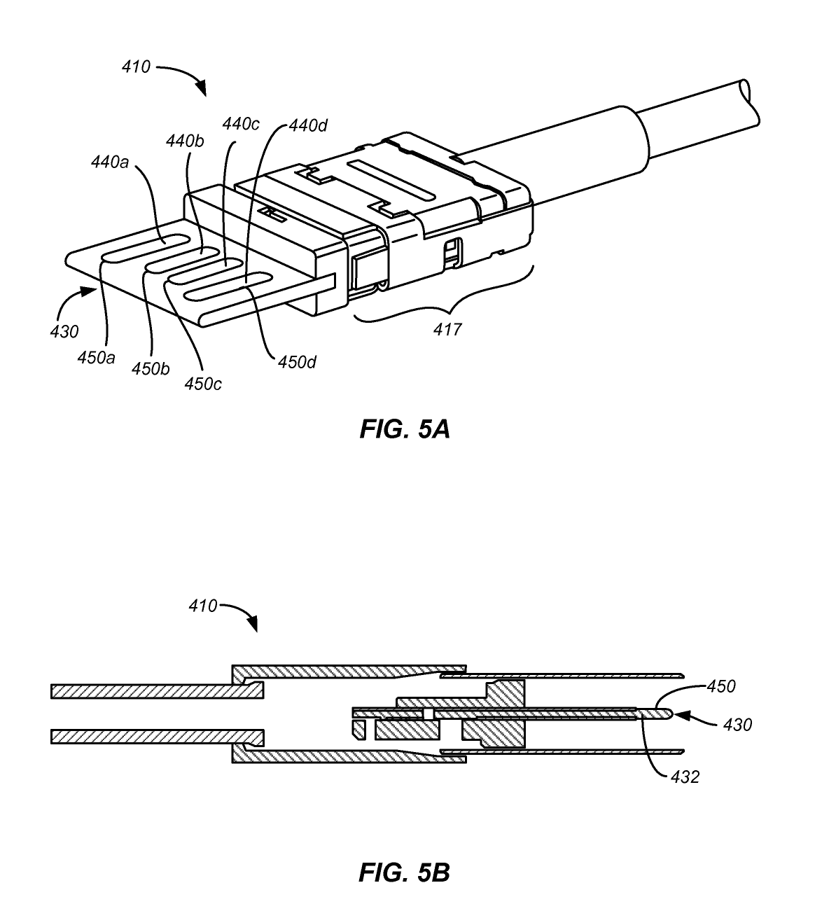

FIGS. 5A and 5B are simplified perspective and cross sectional views, respectively, of a USB plug connector 410 in various stages of manufacture according to still another embodiment of the present invention. Connector 410 is also similar to embodiments discussed above, e.g., plug connectors 110 and 210. However, although tongue 430 includes a PCB 432 like the other embodiments described above, tongue 430 also includes a sticker or label 450 that is adhered to PCB 432. As shown in FIG. 5A, label 450 may include openings 450a-450d and additional openings not shown such that all contacts of connector 410 (e.g., contacts 440a-440d) remain exposed and accessible by contacts of a corresponding USB receptacle connector. Label 450 may provide cosmetic benefits in addition to insulating the contacts of plug connector 410.

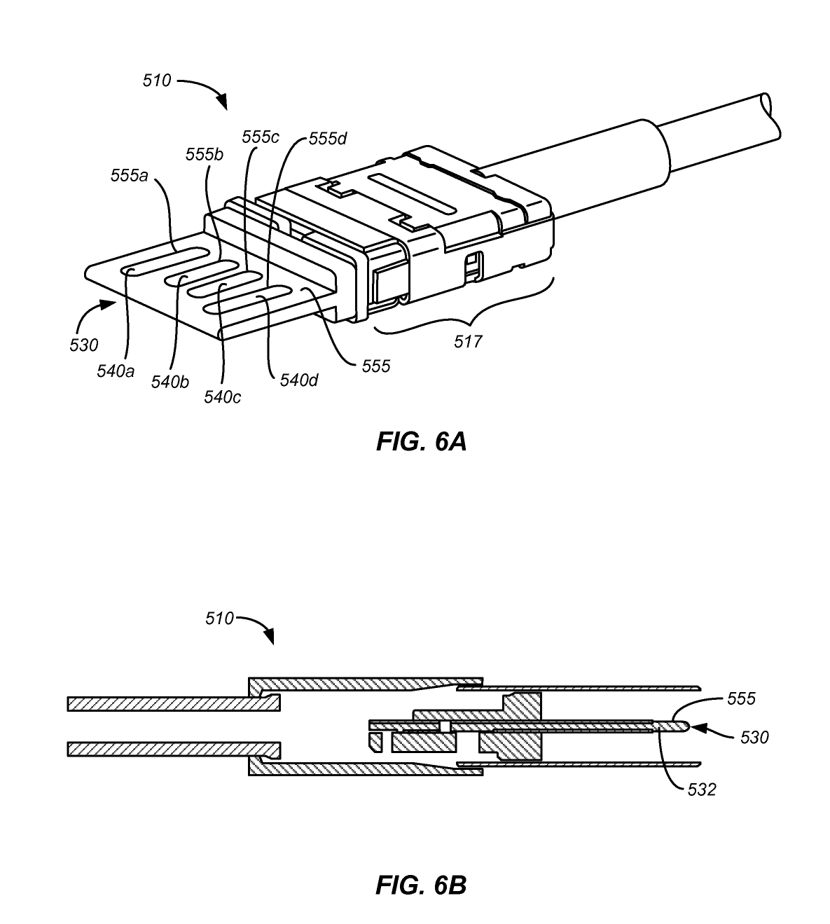

FIGS. 6A and 6B are simplified perspective and cross sectional views, respectively, of a USB plug connector 510 in various stages of manufacture according to still another embodiment of the present invention. Connector 510 is also similar to embodiments discussed above, e.g., plug connectors 110 and 210. However, although tongue 530 may include a PCB 532 like the other embodiments described above, PCB 532 may be inserted molded to form an overmold 555 surrounding PCB 532. As shown in FIG. 6A, overmold 555 may include openings 555a-555d and additional openings (not shown) corresponding to all the contacts of connector 510 (e.g., contacts 540a-540d as well as the contacts not shown in FIG. 6A). Accordingly, the contacts of connector 510 may remain exposed and accessible by contacts of a corresponding USB receptacle connector. Overmold 555 may provide a cosmetic benefit to tongue 530.

An example of an embodiment that may be similar to plug connector 510 is shown in the following figures.

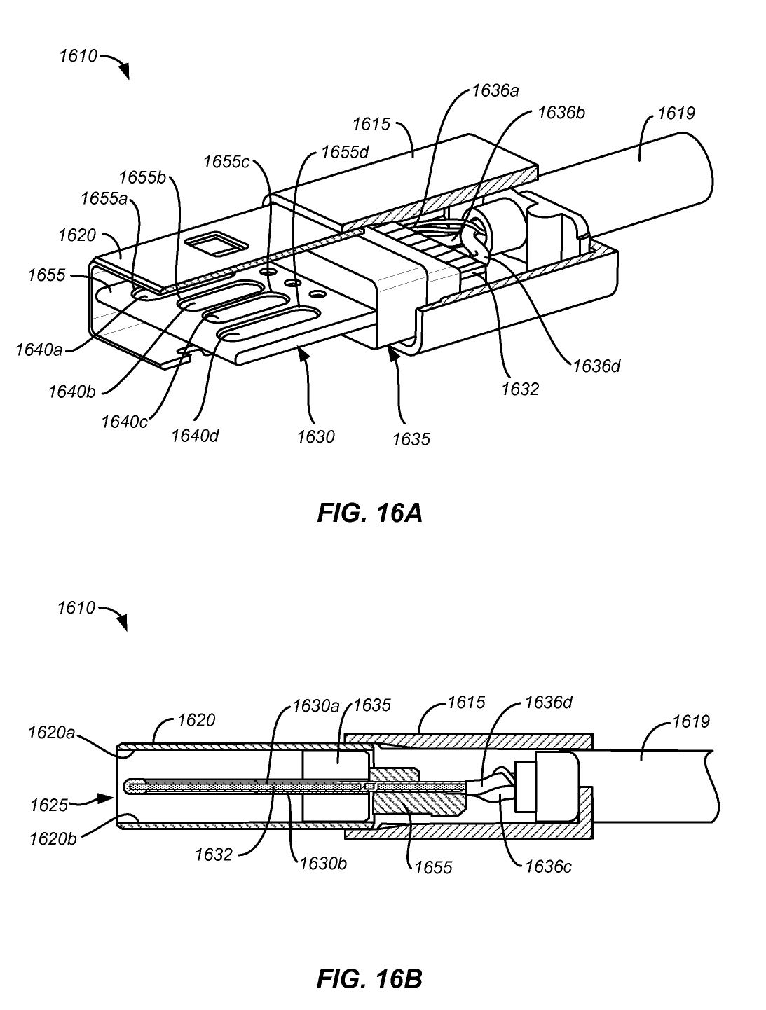

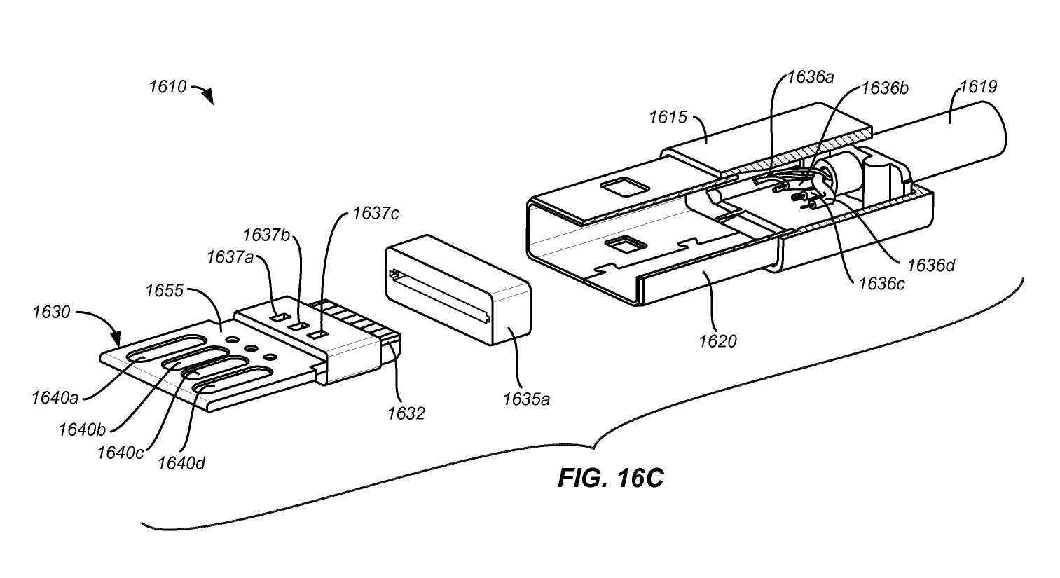

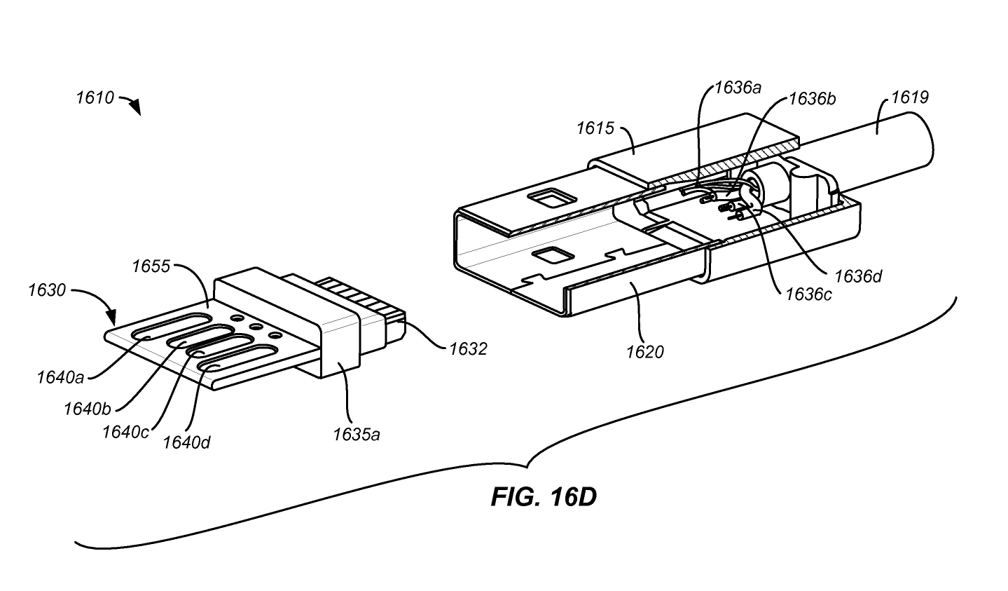

FIGS. 16A and 16B are partial cross sectional perspective and cross sectional side views, respectively, of a USB plug connector 1610 according to one embodiment of the present invention. Again, connector 1610 may be similar to embodiments discussed above, e.g., plug connector 510. However, further details are shown and discussed in relation to plug connector 1610. FIGS. 16A and 16B show that connector 1610 may include a body 1615 and a shell 1620 extending longitudinally away from body 1615 in a direction parallel to the length of connector 1610. Shell 1620 includes an opening 1625 that communicates with a cavity defined by inner surfaces, e.g., first and second inner surfaces 1620a, 1620b of shell 1620, a tongue 1630, and surfaces of support structure 1635.

As shown in FIGS. 16A and 16B, tongue 1630 may be centrally located between first and second inner surfaces 1620a, 1620b and extend in a direction parallel to length of connector 1610. Contacts 1640a-1640d are disposed on a first major surface 1630a and four additional contacts (not shown) are disposed on second major surface 1630b. Tongue 1630 may include a PCB 1632 that is inserted molded to form an overmold 1655 surrounding PCB 1632. As shown in FIG. 16A, overmold 1655 may include openings 1655a-1655d as well as additional openings (not shown) such that overmold 1655 includes openings corresponding to all the contacts of connector 1610 (e.g., contacts 1640a-1640d as well as the four additional contacts not shown). Accordingly, the contacts of connector 1610 may remain exposed and accessible by contacts of a corresponding USB receptacle connector.

In addition to the cosmetic benefits of overmolds discussed herein concerning other embodiments of the present invention, overmolds, e.g., overmolds 1655, may also provide rigidity and wear resistance to a PCB, e.g., PCB 1632. For example, overmold 1655 encloses PCB 1632 and may protect it from wear that occurs during insertion/extraction events, misuse and/or other events where tongue 1630 comes into contact with objects. Thus, overmold 1655 may help to extend the lifetime of connector 1610 as the dielectric materials typically used to make a PCB are not chosen based on their strong wear resistance characteristics. A PCB does not typically have strong rigidity characteristics either. Overmold 1655 may also increase the rigidity of PCB 1632 and tongue 1630 by providing an extra layer of material around tongue 1630.

As mentioned previously, some plug connectors of the present invention may include structural support elements made from materials chosen to allow plug connector tongues to deflect. Connector 1610 may also include a structural support element, e.g., a structural support 1635. Structural support 1635 may provide flexure to PCB 1632 to reduce stress and fatigue on PCB 1632 and allow tongue 1630, along with PCB 1632, to deflect toward and away from first or second inner surfaces 1620a, 1620b during insertion/extraction events. In order to provide this flexure, structural support 1635 may be made from an elastomer that deforms in response to stress, e.g., a mating event, but holds tongue 1630 centrally located between first and second inner surfaces 1620a, 1620b otherwise.

FIGS. 16A and 16B also illustrate individual wires, wires 1636a-1636d, that extend from the interior of cable 1619. Wires 1636a-1636d may directly terminate on PCB 1632, e.g., wires 1636a-1636d may be soldered to PCB 1632. Cable 1619 may include insulated wires corresponding to each unique contact of plug connector 1610 and may be connected to the contacts of plug connector 1610 via PCB 1632. For example, wire 1636d may be a grounding wire, wire 1636c may be a Data+wire, wire 1636b may be a Data−wire, and wires 1636a may be power wires.

Embodiments of the present invention also provide for effective methods of manufacturing plug connector 1610. Examples of these methods are illustrated in the following figures.

FIGS. 16C and 16D are partial cross sectional, exploded perspective views of embodiments of structural support 1635 for assembling with and overmolding on tongue 1630 of plug connector 1610, respectively, according to manufacturing methods of the present invention. As shown in FIG. 16C, tongue 1630 may include one or more interlock recesses, e.g., interlock recesses 1637a-1637c. And although not shown in FIG. 16C, support structure 1635a may include protruding interlock features corresponding to interlock recesses 1637a-1637c. These interlock features—protrusions and corresponding recesses 1637a-1637c—may be configured to align and/or interlock tongue 1630 and support structure 1635a when assembled together. A clearance fit, an interference fit or a snap-fit may hold tongue 1630 and support structure 1635a in their assembled positions. Other embodiments may use different interlock features, e.g., pins and holes, latch features or adhesives.

In another embodiment, a support structure may be overmolded over a portion of tongue 1630. For example, tongue 1630 may be overmolded with a resilient polymer, e.g., LCP or POM, to form a support structure 1635b, as shown in FIG. 16D. In order to increase the bonding strength between tongue 1630 and support structure 1635b, the same materials, compatible materials (i.e., materials of similar chemistry) or blends of compatible materials may be used to form both tongue 1630 and support structure 1635b such that a chemical bond may be created between the elements. Interlock features may also be used to strengthen the bond between tongue 1630 and support structure 1635b. For example, during the overmolding of support structure 1635b, molten plastic may flow into recesses 1637a-1637c and serve as an interlock between support structure 1635b and tongue 1630.

In other embodiments, a support structure may also be integrally formed with tongue 1630, similar to embodiments of plug connectors shown in other FIGS. of the present application.

The structures and methods shown in FIGS. 16A-16D and discussed in relation thereto may also be implemented in various ways in other embodiments of the present invention.

As mentioned above, the methods and structures described above in relation to FIGS. 2A and 2B may be varied in other embodiments. Additional examples of these variations are included in the following figures.

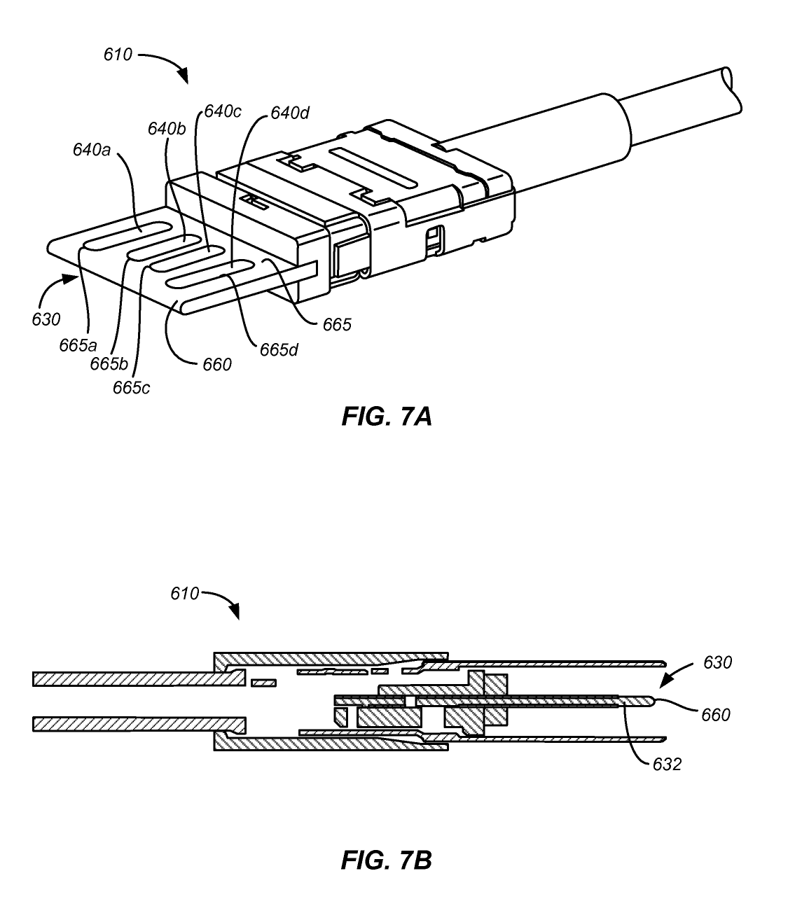

FIGS. 7A and 7B are simplified perspective and cross sectional views, respectively, of a USB plug connector 610 in various stages of manufacture according to still another embodiment of the present invention. Connector 610 is also similar to embodiments discussed above, e.g., plug connectors 110 and 210. However, although tongue 630 may include a PCB 632 like the other embodiments described above, tongue 630 also includes a frame 660 that may be assembled over PCB 632. In addition, a sticker or label 665 may be adhered to frame 660. As shown in FIG. 5A, label 665 may include openings 665a-665d and additional openings corresponding to all the contacts of connector 610 (e.g., contacts 640a-640d as well as the contacts not shown in FIG. 6A). Accordingly, the contacts of connector 610 may remain exposed and accessible by contacts of a corresponding USB receptacle connector. Label 665 may provide cosmetic benefits in addition to insulating the contacts of plug connector 510. Frame 660 may also include openings (not shown) corresponding to the openings of label 665.

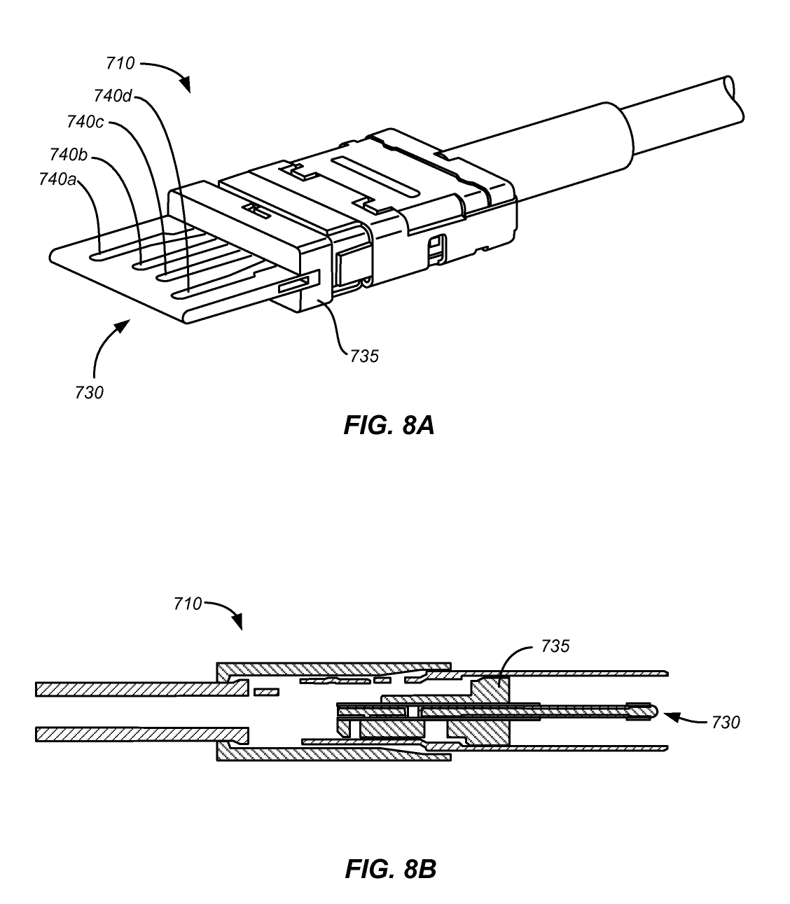

FIGS. 8A and 8B are simplified perspective and cross sectional views, respectively, of a USB plug connector 710 in various stages of manufacture according to still another embodiment of the present invention. Connector 710 is also similar to embodiments discussed above, e.g., plug connectors 110 and 210. However, in contrast with the connector discussed above, connector 710 does not include a PCB. Instead, tongue 730 can be produced via a single shot molding process. For example, contacts of connector 710 (e.g., 740a-740d) may be inserted molded to form a tongue 730 having exposed contacts as shown in FIG. 8A. Tongue 730 may then be assembled with structural support 735, or structural support 735 may be overmolded around a portion of tongue 730.

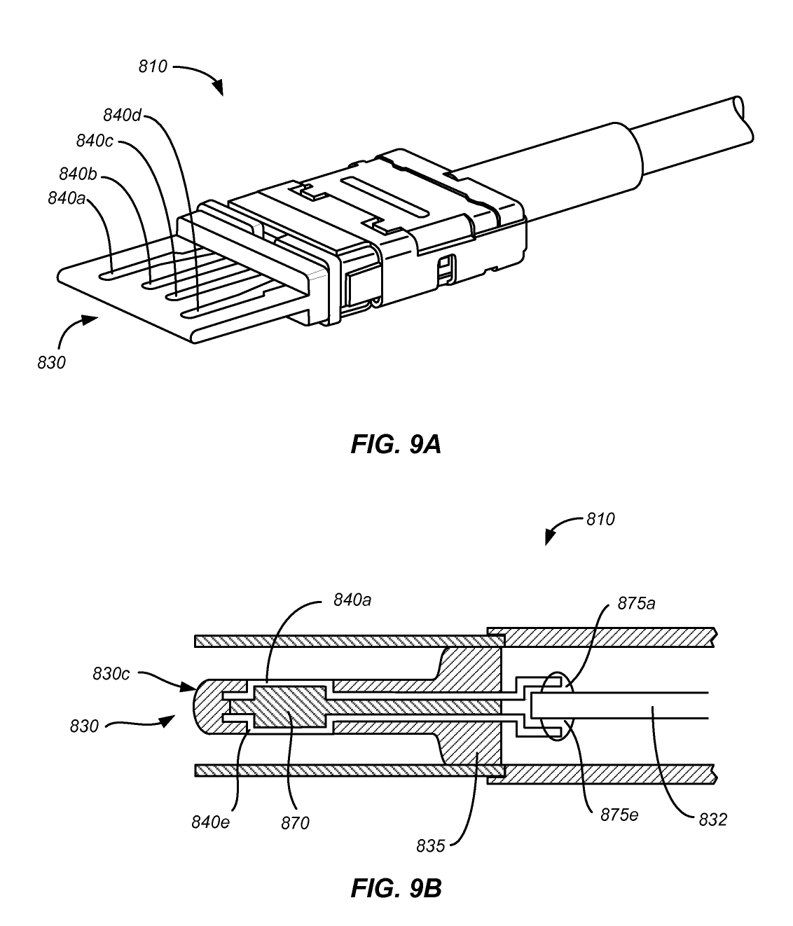

FIGS. 9A and 9B are simplified perspective and cross sectional views, respectively, of a USB plug connector 810 in various stages of manufacture according to still another embodiment of the present invention. Connector 810 is similar to embodiments discussed above, particularly connector 710. Connector 810 does not include a PCB but rather a tongue 830 can be formed via a two shot molding process, as opposed to the one shot molding process of connector 710. The first insert mold shot may be used to form a first portion 870 using a suitable dielectric material, e.g., LCP. As shown in FIG. 9B, first portion 870 may be located between the opposing sets of contacts of connector 810. The second insert mold shot may be used to form a second portion 875 using another dielectric material, e.g., LCP, POM or Nylon. Second portion 875 also forms a tip 830c of tongue 830. Subsequently, an overmolding process may use nylon or another suitable dielectric to form the remaining portion of tongue 830 as well as structural support 835. In this embodiment, the contacts of plug connector 810, e.g., contacts 840a and 840e, are soldered to PCB 832. Contacts of plug connector 810 may be shorted through PCB 832 or otherwise routed to insulated wires of cable connected to connector 810.

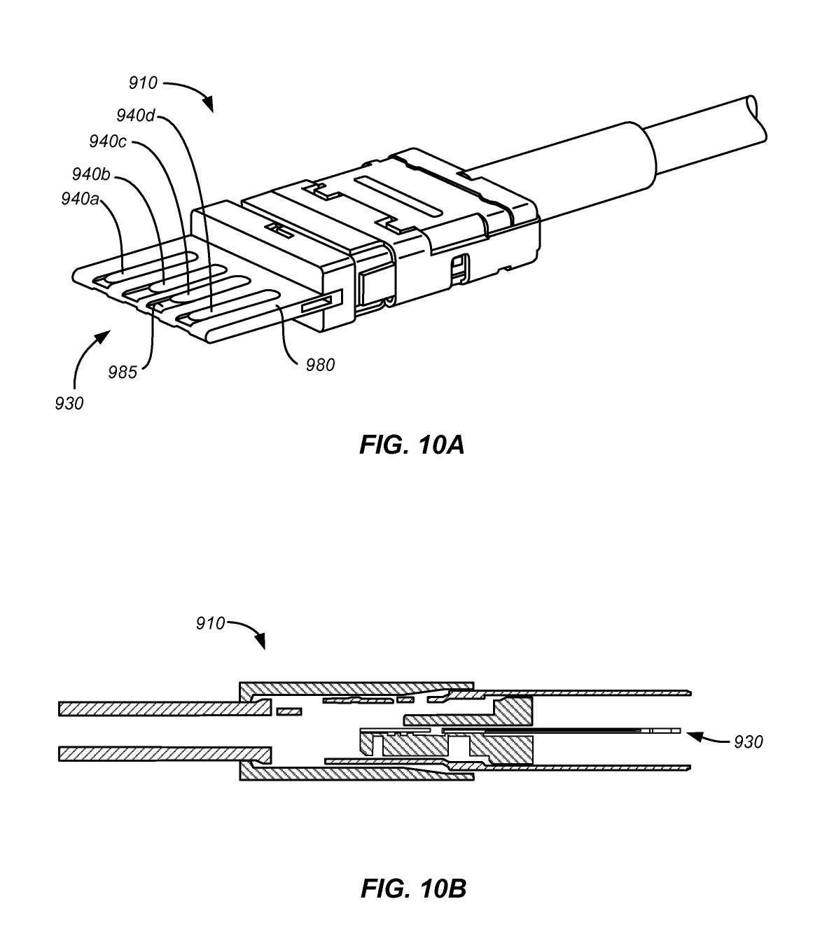

FIGS. 10A and 10B are simplified perspective and cross sectional views, respectively, of a USB plug connector 910 in various stages of manufacture according to still another embodiment of the present invention. Connector 910 is similar to embodiments discussed above, particularly connector 810. Connector 910 includes a frame 980 that includes a clamshell style opening. A flex circuit 985 may be assembled in the clamshell opening of frame 980 in order to form a tongue 930 that includes contacts (e.g., contacts 940a-940d).

The methods of manufacturing discussed above may also be suitable in whole or in part for additional embodiments of plug connectors of the present invention. Examples of these additional embodiments of plug connectors of the present invention are illustrated in the following figures.

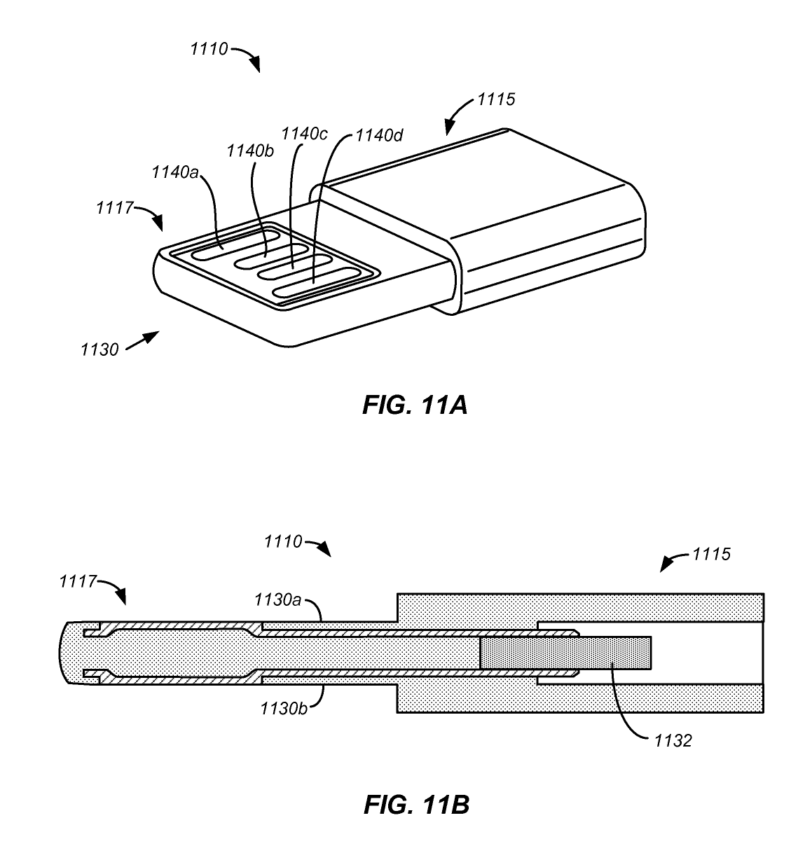

FIGS. 11A and 11B are simplified perspective and cross sectional views, respectively, of a USB plug connector 1100 according to one embodiment of the present invention. Plug connector 1110 includes a body 1115 and a tab 1117 extending longitudinally away from body 1115 in a direction parallel to the length of connector 1110. In contrast with connector 10 and similar variations, connector 1110 does not include a shell. Contacts 1140a-1140d are disposed on a first major surface 1130a and four additional contacts (only contact 1140e is shown in FIG. 11B) are disposed on a second major surface 1130b. As also shown in FIGS. 11A and 11B, tab 1117 may include a bullnose tip 1130c for at least the same reasons discussed above.

Connector 1100 can have a 180 degree symmetrical, double orientation design which enables the connector to be inserted into a corresponding receptacle connector in both a first orientation where surface 1130a is facing up and a second orientation where surface 1130a is rotated 180 degrees and facing down. Specifics of general double or dual orientation designs are discussed in greater detail above. Simply stated, the dual orientation design of connector 1100 allows contacts disposed on first surface 1130a (contacts 1140a-1140d) to mate with contacts of the corresponding receptacle connector in one orientation and contacts disposed on second surface 1130b to mate with contacts of the corresponding receptacle connector in the other orientation. Despite connector 1110 being a dual orientation connector, this embodiment of the present invention may only be received by receptacle connectors specially designed for receiving connector 1100.

Tab 1130 may be made from one or more of a variety of dielectric materials including wear resistant materials such as LCP, POM, Nylon and others. In contrast with connector 10, connector 1110 may not be designed to deflect upon insertion into a corresponding receptacle connector. Instead, connector 1100 may remain rigid during insertion and extraction events. Materials used for making tab 1130 may be chosen accordingly.

Body 1115 is generally the portion of connector 1110 that a user will hold onto when inserting or removing connector 1110 from a corresponding receptacle connector. Body 1115 can be made out of a variety of materials and in some embodiments is made from a dielectric material, such as a thermoplastic polymer formed in an injection molding process. Also, electrical contact to the contacts of surfaces 1130a, 1130b can be made with individual wires in a cable within body 1115. In one embodiment, a cable includes a plurality of individual insulated wires for connecting to contacts of surfaces 1130a, 1130b that are soldered to bonding pads on a PCB housed within body 1115. The bonding pads on the PCB may be electrically coupled to corresponding individual contacts of surfaces 1130a and 1130b. In some embodiments, contacts of one of surfaces 1130a and 1130b to be shorted through tab 1130 or a PCB to corresponding contacts on the other of surfaces 1130a and 1130b and then appropriately routed to the individual wires of a cable within body 1115.

The contacts of tab 1130 can be made from copper, nickel, brass, a metal alloy or any other appropriate conductive material. Plug connector 1110 may include standard USB contacts for power, ground and a pair of differential data signals (e.g., data transmit). For example, contact 1140a may be a ground pin, contact 1140b may be a Data+pin, contact 1140c may be a Data−pin, and contact 1140d may be a power pin (VBUS). As mentioned earlier, the four additional contacts disposed on second major surface 1130b can be positioned so that the contacts on first and second major surfaces 1130a, 1130b are arranged in a symmetric manner and have the same pinout. In this manner, either of two intuitive orientations may be used to mate the contacts of plug connector 1110 with contacts of a corresponding receptacle connector during a mating event.

A sensing circuit as described above may be included with connector 1110 and/or a corresponding receptacle connector.

An example of a particular embodiment of plug connector 1110 is shown in the following figures.

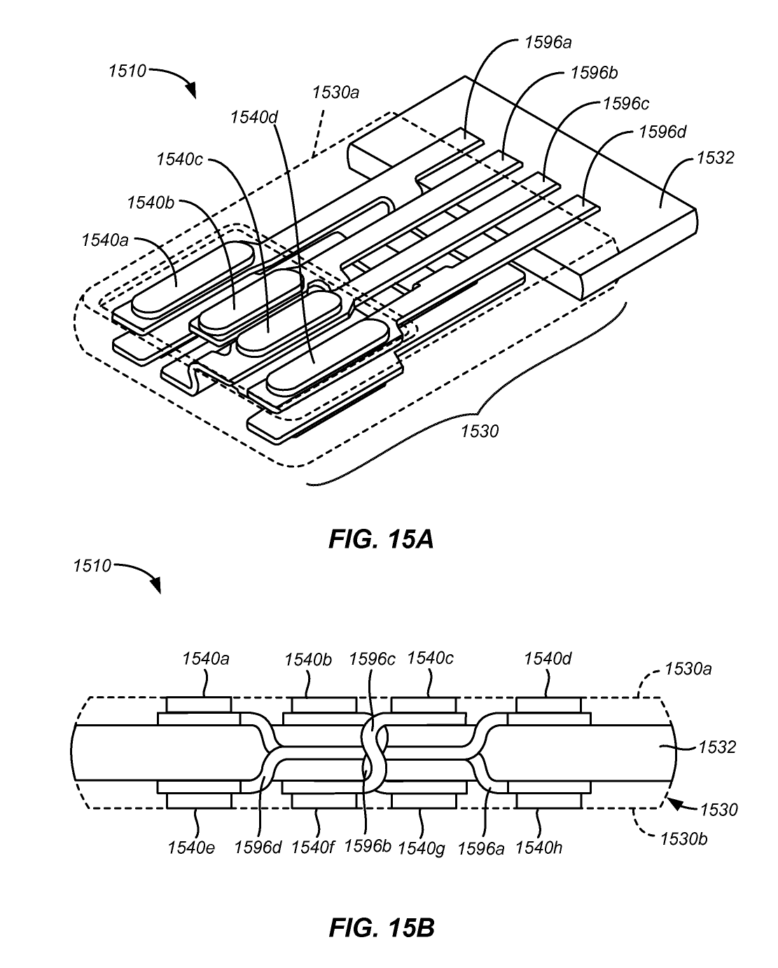

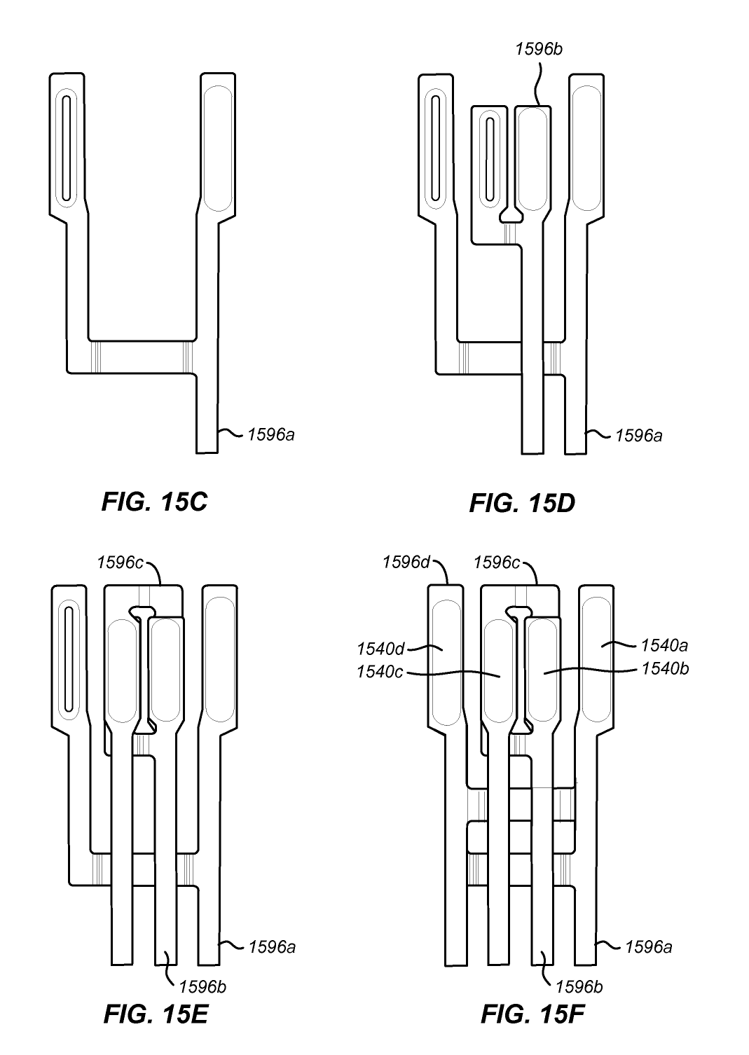

FIGS. 15A and 15B are partially transparent simplified perspective and partially transparent front views, respectively, of a USB plug connector 1510 according to one particular embodiment of connector 1110. Connector 1510 may provide the same pinout on both first and second major surfaces 1530a, 1530b of a tab 1530 using crossover contact frames 1596a-1596d that each include a contact for each of the major surfaces of tab 1530. For example, as shown in FIGS. 15A and 15B, tab 1530 extends in a longitudinal direction and includes contacts 1540a-1540d disposed on first major surface 1530a and contacts 1540e-1540g disposed on second major surface 1530b. Contacts 1540a-1540g may be exposed portions of contact frames 1596a-1596d. Crossover contact frames 1596a-1596d may serve to connect contacts 1540a-1540d to contacts 1540h-1540e, respectively, and contacts 1540a-1540h to PCB 1532, which may be assembled with tab 1530. The configuration of crossover contact frames 1596a-1596d is further illustrated in the following figures.

FIGS. 15C-15F are top views of contact frames 1596a; 1596a and 1596b; 1596a, 1596b and 1596c; and 1596a, 1596b, 1596c and 1596d; respectively, in their positions with respect to each other when embedded in tab 1530. As shown in FIG. 15C-F as well as FIGS. 15A and 15B, a crossover region exists between contacts 1540a-1540d and contacts 1540e-1540h where portions of contact frames 1596a-1596d overlap and cross. The overlapping and crossing of portions of contact frames 1596a-1596d in the crossover region may provide shielding to minimize electromagnetic interference (EMI) from degrading signals transferred through contacts 1540a-1540h.

As with connector 1100, connector 1510 can have a 180 degree symmetrical, double or dual orientation design. Similarly, connector 1510 may include a body having a cable attached thereto like body 1115 or any of the other body embodiments described herein. In one embodiment, a body (not shown in FIGS. 15A-15F) may be assembled with tab 1530, house PCB 1532 and have a cable (not shown in FIGS. 15A-15F) attached thereto. The cable may include a plurality of individual insulated wires for connecting to contacts 1540e-1540h via PCB 1532 that includes solder connections between crossover contact frames 1596a-1596d and its bonding pads.

The contacts of connector 1510 may include contacts for power, ground and a pair of differential data signals (e.g., data transmit). For example, crossover contact frames 1596a-1596d may provide lines for ground, Data+, Data− and power (VBUS), respectively. Accordingly, contacts 1540a and 1540h may be a ground pins, contacts 1540b and 1540g may be a Data+pins, contacts 1540c and 1540f may be a Data−pins, and contacts 1540d and 1540e may power pins (VBUS). In this manner, regardless of the orientation of plug connector 1510, the same pinout may be mated with a corresponding receptacle connector during a mating event.

An added benefit of this embodiment may be that sensing circuitry as discussed in relation to other embodiments contained herein may not be necessary for connector 1510 or a corresponding receptacle connector. This is possible because crossover contact frames 1596a-1596d may provide the same pinout on each of the first and second orientations and handle the routing of power and data received at contacts 1540a-1540h to PCB 1532. In some embodiments, contact frames 1596a-1596d may even directly route power and data to individual wires of a cable connected to connector 1510. Accordingly, features of connector 1510 may be useful for other embodiments described herein.

Contact frames 1596a-1596d can be made from copper, nickel, brass, a metal alloy or any other appropriate conductive material using a metal stamping operation or other machining operations. Alternatively, contact frames 1596a-1596d may be molded.

The contact arrangements shown in FIGS. 15A-15F and discussed in relation thereto may be implemented in various ways in other embodiments, e.g., those embodiments that do not include a PCB disposed between the contacts of the plug connector. Additional embodiments of contact arrangements that may be implemented with plug connector embodiments that may not include PCB anywhere within the plug connector are shown in the following figures.

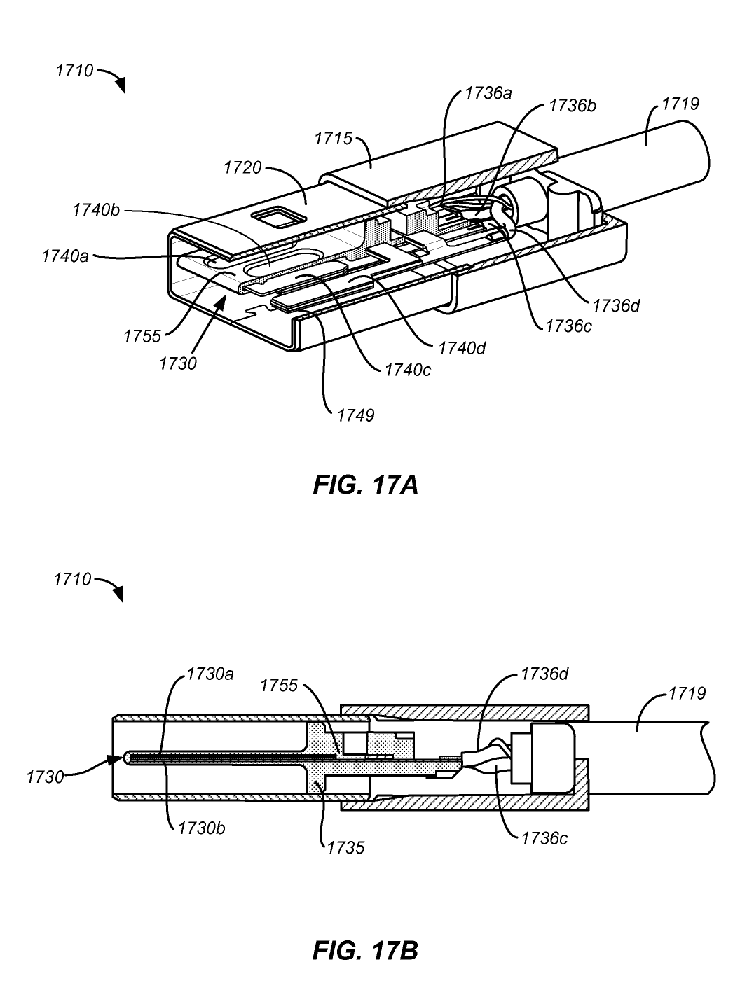

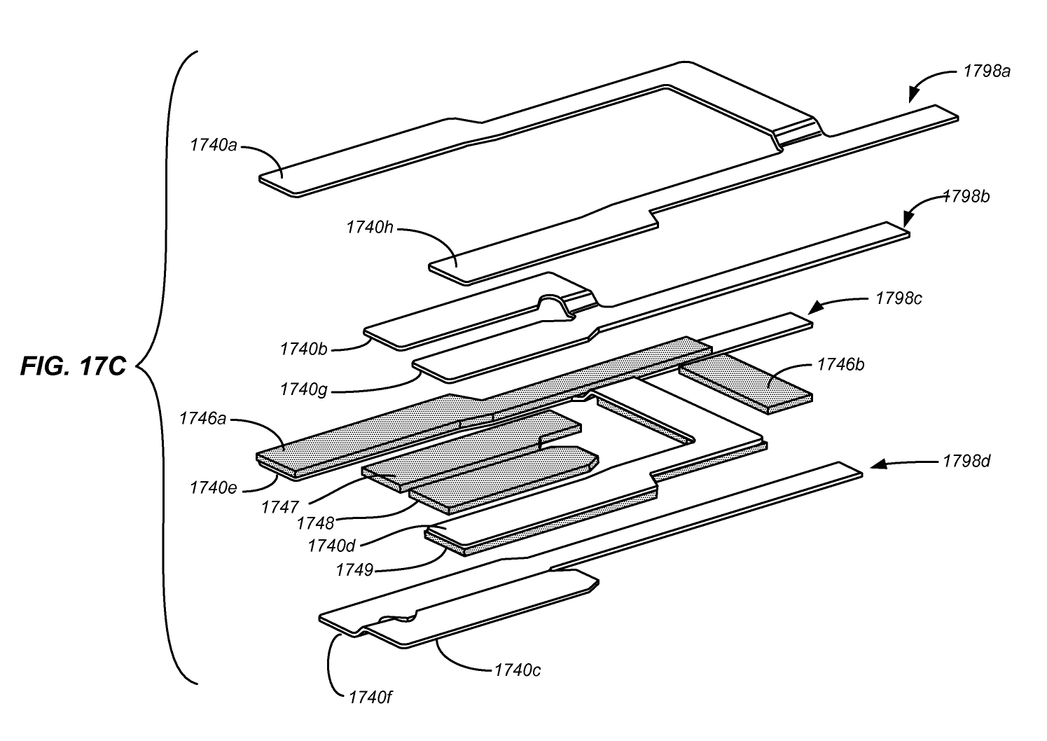

FIGS. 17A and 17B are partial cross sectional perspective and cross sectional side views, respectively, of a USB plug connector 1710 according to one embodiment of the present invention. Plug connector 1710 may be similar to embodiments discussed above, e.g., plug connector 1610. However, plug connector 1710 may not include a PCB. FIGS. 17A and 17B show that connector 1710 may include a body 1715 and a shell 1720 extending longitudinally away from body 1715 in a direction parallel to the length of connector 1710. Shell 1720 includes an opening 1725 that communicates with a cavity. Tongue 1730 may be centrally located within shell 1720 and extend in a direction parallel to the length of plug connector 1710. Contacts 1740a-1740d are exposed on a first major surface 1730a and contacts 1740e-1740h are exposed on a second major surface 1730b. Contacts 1740a-1740h may be exposed portions of contact frames 1798a-1798d.

Crossover contact frames 1798a-1798d may serve to connect contacts 1740a-1740d to contacts 1740h-1740e, respectively, and contacts 1740a-1740h to wires of cable 1719. FIGS. 17A and 17B illustrate insulated wires, wires 1736a-1736d, that extend from the interior of cable 1719. Wires 1736a-1736d may directly terminate on contact frames 1798a-1798d, e.g., wires 1736a-1736d may be soldered to contact frames 1798a-1798d. The Cable 1719 may include wires corresponding to each unique contact of plug connector 1710. For example, wire 1736d may be a grounding wire that connects to contact frame 1798a (contacts 1740a and 1740h), wire 1736c may be a Data+wire that connects to contact frame 1798b (contacts 1740b and 1740g), wire 1736b may be a Data−wire that connects to contact frame 1798d (contacts 1740c and 1740f), and wires 1736a may be power wires that connect to contact frame 1798c (contacts 1740d and 1740e). In this manner, regardless of the orientation of plug connector 1710, the same pinout may be mated with a corresponding receptacle connector during a mating event.

The configuration of crossover contact frames 1798a-1798d is further illustrated in the following figure.

FIG. 17C is an exploded view of contact frames 1798a-1798d of plug connector 1710. As can be understood from FIG. 17C, a crossover region exists between contacts 1740a-1740d and contacts 1740e-1740h where portions of contact frames 1798a-1798d overlap and cross. Insulative spacers may be placed in this crossover region. For example, strips of electrical insulation materials, e.g., elastomers or other polymers with good electrical insulation properties, may be placed and/or adhered to the surfaces of contact frames 1798a-1798d adjacent to other surfaces of contact frames 1798a-1798d in plug connector 1710, as shown in FIG. 17C. For example, spacers 1746a and 1746b may shield portions of contact frame 1798c from portions of contact frame 1798a. Spacers 1747 and 1748 may shield portions of contact frame 1798b from portions of contact frame 1798d. Spacer 1749 may shield portions of contact frame 1798c from portions of contact frame 1798a.

Depending the amount of EMI that is occurring between the contacts of plug connector 1710, more or less and/or thicker or thinner insulative spacers may be implemented. For example, if additional shielding is required more and/or thicker insulative spacers may be placed in the crossover region between contact frames 1798a-1798d. The overlapping and crossing of portions of contact frames 1798a-1798d in the crossover region in addition to the insulative spacers may provide shielding from EMI caused by signals passing through 1740a-1740h, which EMI may degrade the signals transferred through contacts 1740a-1740h.

Overmold 1755 may be formed around spacers 1746-1749 and contact frames 1798a-1798d to form tongue 1730. As discussion herein, tongue overmolds may provide cosmetic, rigidity and wear resistance benefits. Materials used for other tongue overmold embodiments discussed herein may also be used for overmold 1755.

The design of plug connector 1710, as with plug connector 1510, may be a 180 degree symmetrical, double or dual orientation design. An added benefit of contact frames 1798a-1798d may be that sensing circuitry as discussed in relation to other embodiments contained herein may not be necessary for connector 1710 or a corresponding receptacle connector for reasons similar to those mentioned concerning plug connector 1510.

As shown in FIG. 17B, plug connector 1710 may also include a structural support 1735 integrally formed with overmold 1755. Structural support 1735 may provide flexure to tongue 1730 to reduce stress and fatigue on tongue 1730 and allow tongue 1730 to deflect during insertion/extraction events. In other embodiments, structural support 1735 may be separately overmolded over overmold 1755 or separately formed and then assembled with tongue 1730 using a clearance fit, an interference fit or a snap-fit or the like.

Contact frames 1798a-1798d can be made from copper, nickel, brass, a metal alloy or any other appropriate conductive material using a metal stamping operation or other machining operations. Alternatively, contact frames 1798a-1798d may be molded.

An example of another plug connector embodiment that may not include PCB is shown in the following figures.

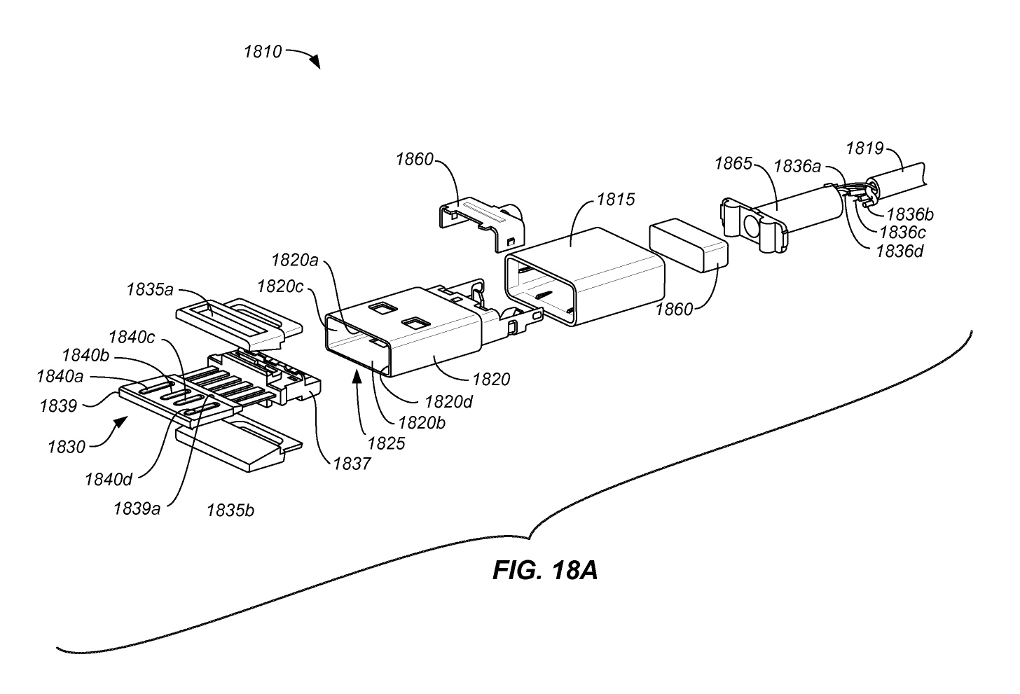

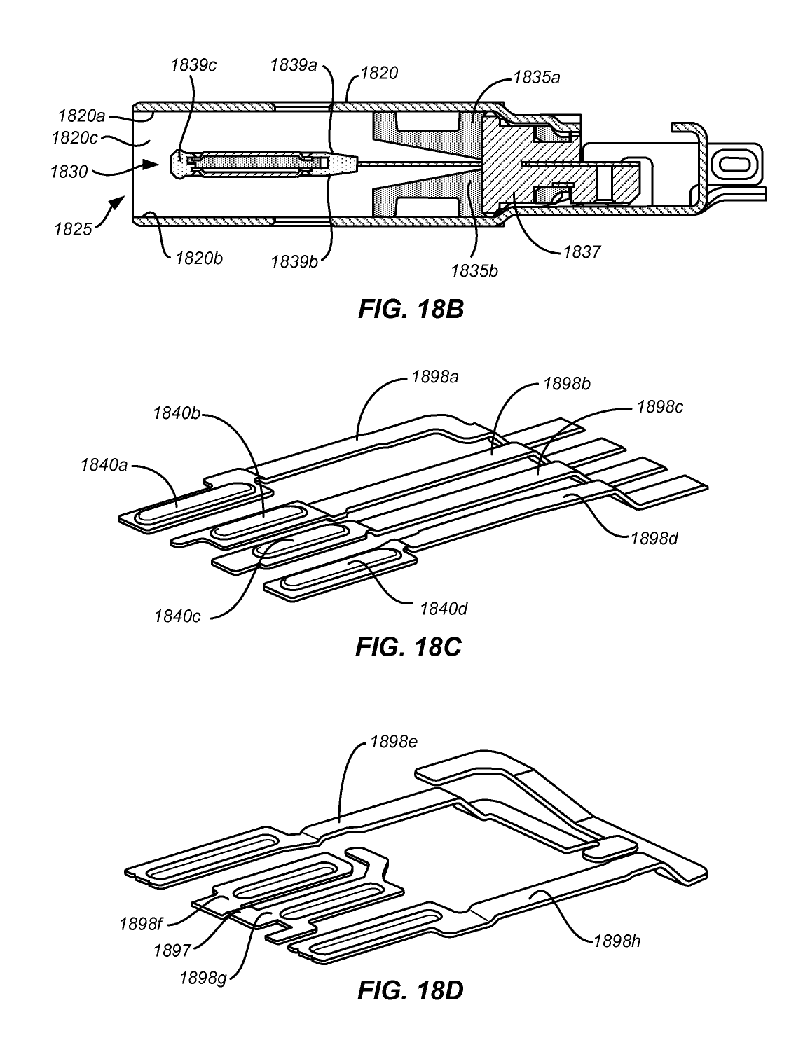

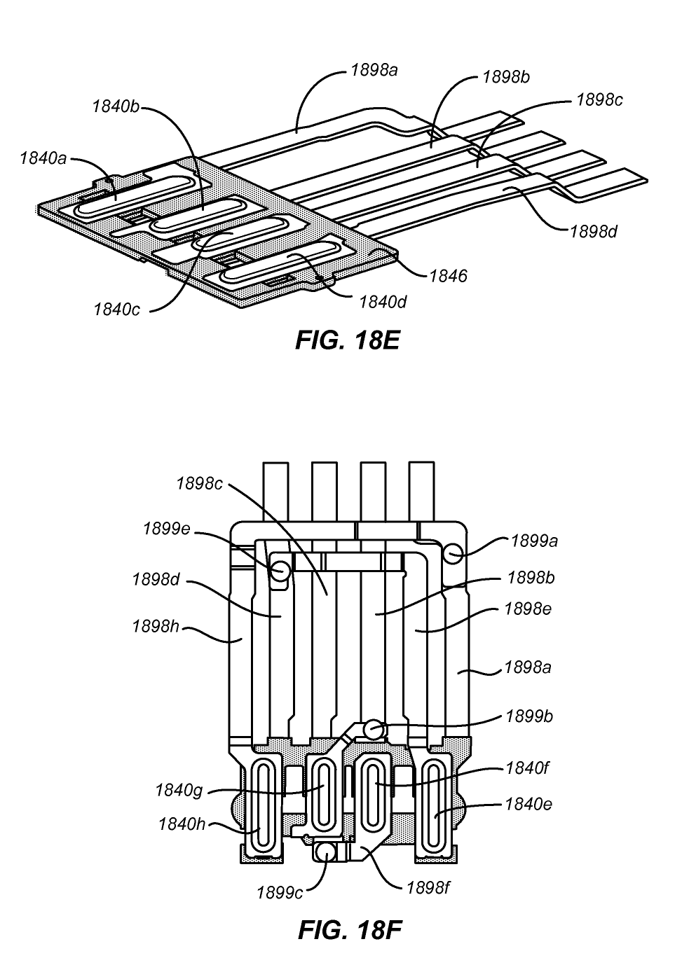

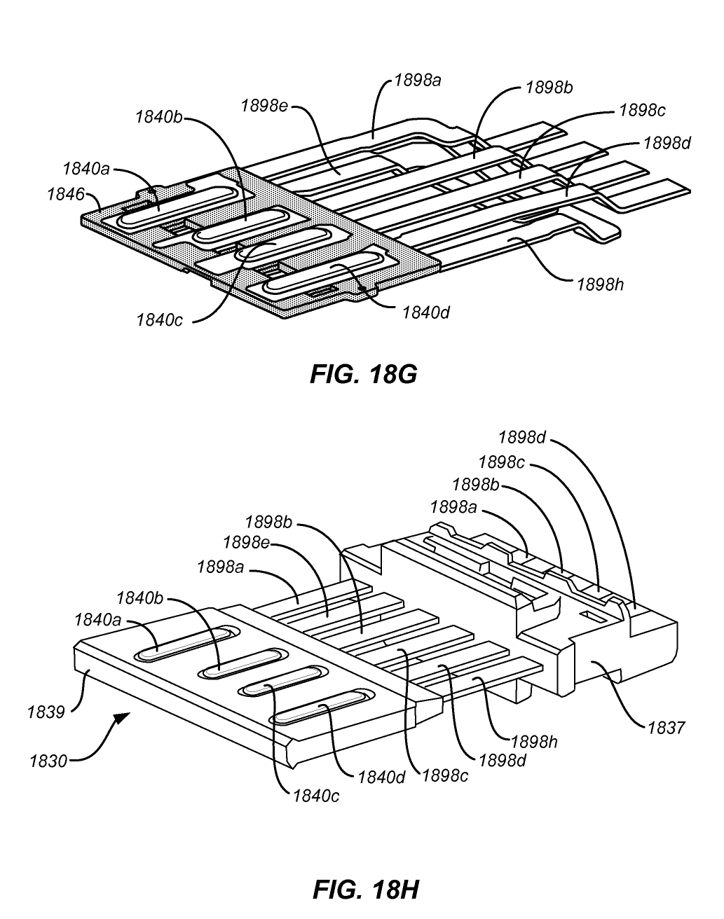

FIGS. 18A and 18B are exploded and cross sectional side views, respectively, of a USB plug connector 1810 according to an embodiment of the present invention. Plug connector 1810 may be similar to embodiments discussed above which does not include a PCB, e.g., plug connector 1710. As shown in FIGS. 18A and 18B, connector 1810 includes a body 1815 and a shell 1820 extending longitudinally away from body 1815 in a direction parallel to the length of connector 1810. Shell 1820 includes an opening 1825 that communicates with a cavity defined by first, second, left and right inner surfaces 1820a-1820d of shell 1820, a tongue 1830, and first and second supports elements 1835a, 1835b assembled with a base 1837. Tongue 1830 may be centrally located between first and second inner surfaces 1820a, 1820b and extend parallel to the length of connector 1810. Tongue 1830 includes contacts 1840a-1840d exposed at a first major surface 1839a of a tip 1839 and four additional contacts (e.g., contacts 1840e-1840h, as shown in FIG. 18F) exposed on a second major surface 1839b. Contacts 1840a-1840h can be made from copper, nickel, brass, a metal alloy such as a copper-titanium alloy or any other appropriate conductive material. As shown in FIGS. 18A and 18B, tongue 1830 may also include a bullnose tip 1839c for reasons that will be explained below.

Connector 1810 can have a 180-degree symmetrical, double orientation design that enables the connector to be inserted into a corresponding receptacle connector in either a first orientation where surface 1839a is facing up or a second orientation where surface 1839a is rotated 180 degrees and facing down. To allow for the orientation agnostic feature of connector 1810, tongue 1830 is not polarized. That is, tongue 1830 does not include a physical key that is configured to mate with a matching key in a corresponding receptacle connector designed to ensure that mating between the two connectors only occurs in a single orientation. Instead, if tongue 1830 is divided into top and bottom halves along a horizontal plane that bisects the center of tongue 1830 along its width, the physical shape of the upper half of tongue 1830 is substantially the same as the physical shape of the lower half. Similarly, if tongue 1830 is divided into left and right halves along a vertical plane that bisects the center of tab along its length, the physical shape of the left half of tongue 1830 is substantially the same as the shape of the right half. Additionally, contacts 1840a-1840d and contacts 1840e-1840g can be positioned so that they are arranged in a symmetric manner. Accordingly, contacts 1840a-1840d can mate with contacts of the corresponding receptacle connector in one orientation and contacts 1840e-1840h (shown in FIG. 18F) can mate with contacts of the corresponding receptacle connector in the other orientation.

Tongue 1830 may be coupled to base 1837, which can be made from a variety of dielectric materials, including flexible polymers and polyamides. The materials used to form tongue 1830 and/or base 1837 may be chosen such that tongue 1830 deflects either toward first or second inner surfaces 1820a, 1820b of shell 1820 when connector 1810 is inserted into a corresponding receptacle connector, e.g., a female USB connector. This deflection may occur as bullnose tip 1839c comes into contact with internal features of a corresponding receptacle connector, causing tongue 1830 to deflect toward an appropriate region within a corresponding receptacle connector and allowing contacts 1830a-1830d or 1830e-1830h of plug connector 1810 to mate with contacts on the corresponding receptacle connector.

As discussed above, tongue 1830 may be centrally located within opening 1825 of shell 1820. For example, tongue 1830 may be positioned within opening 1825 such that its distance from first and second inner surfaces 1820a, 1820b always causes connector 1810 to deflect toward the appropriate region within a corresponding receptacle connector regardless of whether plug connector 1810 is in the first or second orientation, as described above. Portions of tongue 1830 may deform and deflect in different manners in order to put its contacts in position to mate with the contacts of the corresponding receptacle connector. Depending on the materials of the individual components of tongue 1830, the size of tongue 1830 may be varied such that tongue 1830 elastically deforms as necessary during mating events.

Body 1815 is generally the portion of connector 1810 that a user will hold onto during mating events. Body 1815 can be made out of a variety of materials and in some embodiments is made from a dielectric material, such as a thermoplastic polymer formed in an injection molding process. A portion of a cable 1819 and shell 1820 may extend within and be enclosed by body 1815. To prevent cable 1819 from being damaged when flexed during normal use (e.g., mating events), a strain relief element 1865 (e.g., a structure made from elastomers) may be formed over or assembled with the portion of cable 1819 closest to body 1815, as shown in FIG. 18A.

In one embodiment, cable 1819 includes a plurality of individual insulated wires 1836a-1836d for connecting to contacts 1840a-1840h. The electrical connection between insulated wires 1836a-1836d and contacts 1840a-1840h can be formed by soldering wires 1836a-1836d to ends of contact frames 1898a-1898d (as shown in FIGS. 18C, 18D and 18H). As further discussed below, contacts 1840a-1840h may be exposed portions of contact frames 1898a-1898h. Accordingly, contact frames 1898a-1898h can route electrical signals between wires 1836a-1836d and contacts 1840a-1840h. A polymer innermold 1855 may be formed around the connection between wires 1836a-1836d and the ends of contact frames 1898a-1898d. A metallic shield cap 1860 may be assembled over innermold 1855 and with shell 1820 to increase electromagnetic interference and electromagnetic compatibility performance (“EMI/EMC performance”) of connector 1810. The configuration of contact frames 1898a-1898h is further illustrated in the following figures.

FIGS. 18C-18H illustrate contact frames 1898a-1898h in various stages of assembly according to an embodiment of the present invention. FIG. 18C show a first set of contact frames 1898a-1898d shaped to extend through base 1837 and form a portion of tongue 1830 with raised protuberances that function as contacts 1840a-1840d. FIG. 18D shows a second set of contact frames 1898e-1898h having raised protuberances that function as contacts 1840e-1840h. Contact frames 1898e-1898h may be shaped to be coupled with the first set of contact frames 1898a-1898d such that contacts 1840a-1840d are electrically connected to contacts 1840h-1840e, respectively. Contact frames 1898a-1898e and 1898h may also extend into base 1837, while contact frames 1898f and 1898g do not extend into base 1837. As shown in FIG. 18D, contact frames 1898f and 1898g may be connected via an arm 1897. The shape of contact frames 1898f, 1898g and arm 1987 can minimize or reduce electrical stub and thereby minimize insertion loss, allowing for improved signal integrity for contacts 1840b, 1840d, 1840g and 1840f, which may be differential data contacts, as discussed below.

As shown in FIG. 18E, a insulative spacer 1846 may be insert molded over and between portions of contacts 1898a-1898d to electrically shield and isolate contacts 1840a-1840h, even when assembled as shown in FIG. 18F. As such, portions of contact frames 1898a-1898d can overlap and cross contact frames 1898e-1898h while maintaining acceptable levels of EMI/EMC performance. Spacer 1846 can be made from dielectric materials, e.g., elastomers or other polymers with good electrical insulation properties. A larger or smaller, thicker or thinner and/or otherwise shaped insulative spacer 1846 may be implemented depending on the amount of EMI that is occurring between the contacts and/or contact frames of plug connector 1810. For example, if additional shielding is required, insulative spacer 1846 may be thickened where any one of contact frames 1898a-1898d overlap any one of contact frames 1898e-1898h, thereby shielding EMI that could potentially degrade the signals passing to or from contacts 1840a-1840h via contact frames 1898a-1898h.

In order to achieve the 180-degree symmetrical, double or dual orientation design of connector 1810, contact frames 1898e-1898h may be electrically connected to contact frames 1836a-1836d such that the same pinout or arrangement of contact types (e.g., data, power, ground) is provided at first and second surfaces 1839a, 1839b. Accordingly, as shown in FIG. 18F, contacts 1840a-1840d are electrically connected with contacts 1840h-1840e, respectively, via the coupling (e.g., welding or otherwise electrically connecting) to the first and second set of contact frames. More specifically, a weld 1899a (e.g., a laser weld) may electrically couple contact frame 1898a to contact frame 1898h, thereby coupling contacts 1840a and 1840h; a weld 1899b may electrically couple contact frame 1898b to contact frame 1898g, thereby electrically coupling contacts 1840b and 1840g; a weld 1899c may electrically couple contact frame 1898c to contact frame 1898f, thereby electrically coupling contacts 1840c and 1840f; and a weld 1899e may electrically couple contact frame 1898e to contact frame 1898d, thereby electrically coupling contacts 1840d and 1840e.

As with standard USB plug connectors, plug connector 1810 may include contacts for power, ground and a pair of differential data signals (e.g., data transmit). Cable 1819 may include wires corresponding to each of these unique contacts. As discussed above, wires 1836a-1836d may directly terminate on contact frames 1836a-1836d in order to couple with contacts 1840a-1840h. For example, wire 1836d may be a grounding wire that connects to contacts 1840d and 1840e via contact frames 1898d and 1898e, wire 1836c may be a Data+wire that connects to contacts 1840c and 1840f via contact frames 1898c and 1898f, wire 1836b may be a Data−wire that connects contacts 1840b and 1840g via contact frames 1898b and 1898g, and wires 1836a may be power wires that connect to contacts 1840a and 1840h via contact frames 1898a and 1898h. In this manner, regardless of the orientation of plug connector 1810, the same pinout may be mated with a corresponding receptacle connector during a mating event.

The design of plug connector 1810, as with plug connector 1510, may be a 180-degree symmetrical, double or dual orientation design. An added benefit of using contact frames, e.g., frames 1898a-1898h may be that sensing circuitry as discussed in relation to other embodiments contained herein may not be necessary for connector 1810 or a corresponding receptacle connector for reasons similar to those mentioned concerning plug connector 1510.

As mentioned earlier, plug connector 1810 may also include a base 1837 and first and second supports elements 1835a, 1835b assembled with a base 1837. The combination of supports elements 1835a, 1835b and base 1837 may support tongue 1830 as it flexes during insertion/extraction events in order to reduce stress and fatigue experienced by, e.g., contacts frames 1898a-1898h of tongue 1830. Base 1837 may be overmolded over contact frames 1898a-1898e and 1898g or separately formed and then assembled with the rest of tongue 1730 using a clearance fit, an interference fit, a snap-fit or the like. In another embodiment, supports elements 1835a, 1835b may be overmolded separately or integrally with base 1837. Supports elements 1835a, 1835b may be made from a resilient polymer, e.g., LCP or POM. Overmolding may also be used to form tip 1839 over spacer 1846 and around the contacts of contact frames 1898a-1898h, as shown in FIG. 18H. Tip 1839 may provide cosmetic, rigidity and wear resistance benefits. Materials used for other tongue overmold embodiments discussed herein may also be used for tip 1839. Alternatively, tip 1839 may be assembled on contact frames 1898a-1898h.

Contact frames 1898a-1898h can be made from copper, nickel, brass, a metal alloy such as a copper-titanium alloy or any other appropriate conductive material using a metal stamping operation or other machining operations. Alternatively, contact frames 1898a-1898h may be molded. Contacts 1840a-1840h may be made from the same material as contacts frames 1898a-1898h. In addition, contacts 1840a-1840h may be plated with nickel and/or gold.

It will be appreciated that connector 1810 is illustrative and that variations and modifications are possible. The shapes and number of contact frames of connector 1810 can be varied in ways not specifically described here. Further, while the contact frames as described above as being coupled, i.e., via welding, at particular locations, it is to be understood that these weld points can vary for contacts frames having different shapes and configurations. Further, the contact frames of connector 1810 may be replaced with a tongue-shaped element made from a metallic material or a polymer and not configured to carry signals. In this embodiment, a flex circuit having contacts may simply be wrapped around the tongue-shaped element to provide a dual orientation connector such as a USB connector. Embodiments of the present invention can be realized in a variety of apparatus including cable assemblies, docking stations and flash drives.

The structures and methods shown in FIGS. 18A-18H and discussed in relation thereto may also be implemented in various ways in other embodiments of the present invention.

An example of another embodiment of the present invention is shown in the following figures.

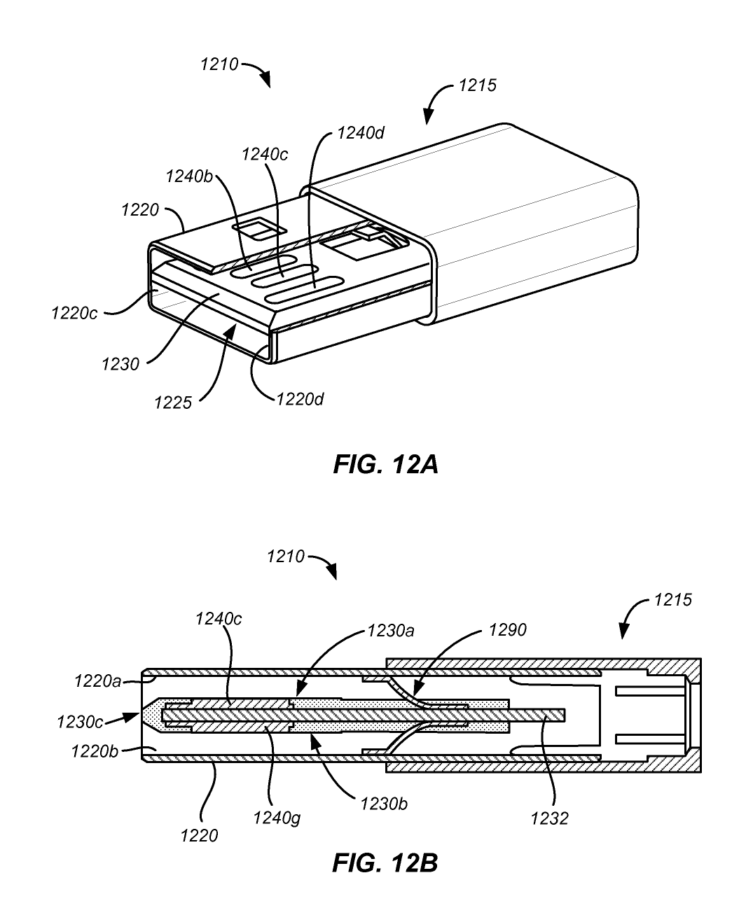

FIGS. 12A and 12B are partial cross sectional perspective and cross sectional views, respectively, of a USB plug connector 1210 according to one embodiment of the present invention. Connector 1210 includes a body 1215 and a shell 1220 extending longitudinally away from body 1215 in a direction parallel to the length of connector 1210. Shell 1220 includes an opening 1225 that communicates with a cavity defined in part by first, second, left and right inner surfaces 1220a-1220d of shell 1220 and a tongue 1230. As shown in FIGS. 12A and 12B, tongue 1230 may be centrally located within shell 1220 and extend parallel to the length of connector 1210. Contacts 1240a-1240d are disposed on a first major surface 1230a and four additional contacts (only contact 1240g is shown in FIG. 1B) are disposed on a second major surface 1230b. As also shown in FIGS. 12A and 12B, tongue 1230 may include a bullnose tip 1230c for reasons that will be explained again below.

As shown in FIGS. 12A and 12B, connector 1210 can have a 180 degree symmetrical, double orientation design which enables the connector to be inserted into a corresponding receptacle connector in both a first orientation where surface 1230a is facing up or a second orientation where surface 1230a is rotated 180 degrees and facing down. Specifics of general double or dual orientation design are discussed in greater detail above. Simply stated, contacts disposed on first surface 1230a (contacts 1240a-1240d) mate with contacts of the corresponding receptacle connector in one orientation and contacts disposed on second surface 1230b mate with contacts of the corresponding receptacle connector in the other orientation.

Tongue 1230 may be a PCB having contacts, which PCB may be overmolded with one or more of a variety of dielectric materials including flexible, wear resistant materials such as LCP, POM, Nylon and others. Tongue 1230 may vertically translate either toward first or second inner surfaces 1220a, 1220b of shell 1220 when connector 1210 is inserted into a corresponding receptacle connector. This vertical translation may be facilitated by an elevator mechanism 1290, e.g., a spring or other vertical translation guide, that may not allow tongue 1230 to move horizontally or pivot. Elevator mechanism 1290 may be engaged as bullnose tip 1230c comes into contact with internal features of a corresponding receptacle connector during an insertion event and may vertically translate tongue 1230 to the appropriate region within a corresponding receptacle connector, allowing contacts disposed on either surface 1230a or 1230b of the plug connector 1210 to mate with contacts on the corresponding receptacle connector.

As mentioned earlier, tongue 1230 may be centrally located within opening 1225 of shell 1220. For example, tongue 1230 may be positioned within opening 1225 such that its distance from first and second inner surfaces 1220a, 1220b causes connector 1210 to always vertically translate, with the assistance of bullnose tip 1230c and elevator mechanism 1290, toward the appropriate region within a corresponding receptacle connector regardless of whether plug connector 1210 is in the first or second orientation, as described above.

Body 1215 is generally the portion of connector 1210 that a user will hold onto when inserting or removing connector 1210 from a corresponding receptacle connector. Body 1215 can be made out of a variety of materials and in some embodiments is made from a dielectric material, such as a thermoplastic polymer formed in an injection molding process. While not shown in FIG. 12A or 12B, a cable and a portion of shell 1220 may extend within and be enclosed by body 1215. In addition, electrical contact to the contacts of surfaces 1230a, 1230b can be made with individual wires in a cable within body 1215. In one embodiment, a cable includes a plurality of individual insulated wires for connecting to contacts of surfaces 1230a, 1230b that are soldered to bonding pads on a PCB housed within body 1215 or on tongue 1230 when tongue 1230 is a PCB. The bonding pads on the PCB may be electrically coupled to corresponding individual contacts of surfaces 1230a and 1230b. In some embodiments, contacts of one of surfaces 1230a and 1230b to be shorted through tongue 1230 to corresponding contacts on the other of surfaces 1230a and 1230b and then appropriately routed to the individual wires of a cable within body 1215.

The contacts of tongue 1230 can be made from copper, nickel, brass, a metal alloy or any other appropriate conductive material. In some embodiments, contacts can be printed on surfaces PCB 1232. As with standard USB plug connectors, plug connector 1210 may include contacts for power, ground and a pair of differential data signals (e.g., data transmit). For example, contact 1240a (not shown in FIG. 12A) may be a ground pin, contact 1240b may be a Data+pin, contact 1240c may be a Data−pin, and contact 1240d may be a power pin (VBUS). As mentioned earlier, the four additional contacts disposed on second major surface 1230b can be positioned so that the contacts on first and second major surfaces 1230a, 1230b are arranged in a symmetric manner and have the same pinout. In this manner, either of two intuitive insertion orientations may result in the same plug connector 1210 pinout being mated with corresponding contacts of a receptacle connector during a mating event.

A sensing circuit as described above may be included with connector 1210 and/or a corresponding receptacle connector.

An example of another embodiment of the present invention is shown in the following figures.

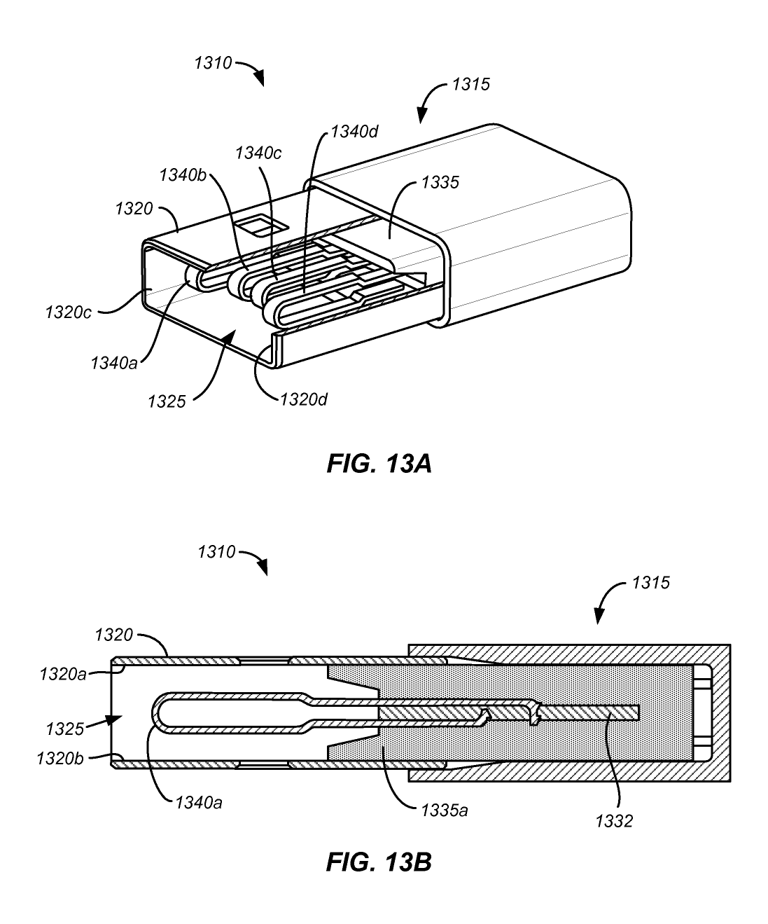

FIGS. 13A and 13B are partial cross sectional perspective and cross sectional views, respectively, of a USB plug connector 1310 according to one embodiment of the present invention. Connector 1310 includes a body 1315 and a shell 1320 extending longitudinally away from body 1315 in a direction parallel to the length of connector 1310. Shell 1320 includes an opening 1325 that communicates with a cavity defined by first, second, left and right inner surfaces 1320a-1320d of shell 1320, spring contacts 1340a-1340d, and a support structure 1335. As shown in FIGS. 13A and 13B, spring contacts 1340a-1340d may be centrally located between first and second inner surfaces 1320a, 1320b and extend parallel to the length of connector 1310. As also shown in FIGS. 13A and 13B, a bullnose tip may be formed at the distal ends of spring contacts 1340a-1340d.

As shown in FIGS. 13A and 13B, connector 1310 can have a 180 degree symmetrical, double orientation design which enables the connector to be inserted into a corresponding receptacle connector in both a first orientation where surface 1330a is facing up or a second orientation where surface 1330a is rotated 180 degrees and facing down. To allow for the orientation agnostic feature of connector 1310, spring contacts 1340a-1340d are not polarized. Specifics of general double or dual orientation designs are discussed in detail above. Simply stated, one side of spring contacts 1340a-1340d mate with contacts of a corresponding receptacle connector in one orientation and the other side of spring contacts 1340a-1340d may mate with contacts of a corresponding receptacle connector in the other orientation.

Structural support 1335 may be made from a variety of dielectric materials, including flexible polymers. The materials used to form structural support 1335 may be chosen such that spring contacts 1340a-1340d deflects either toward first or second inner surfaces 1320a, 1320b of shell 1320 when connector 1310 is inserted into a corresponding receptacle connector. This deflection may occur as the distal tip of spring contacts 1340a-1340d, which may be a bullnose tip, comes into contact with internal features of a corresponding receptacle connector and leads spring contacts 1340a-1340d to the appropriate region within a corresponding receptacle connector, allowing spring contacts 1340a-1340d to mate with contacts on the corresponding receptacle connector.

As mentioned earlier, spring contacts 1340a-1340d may be centrally located within opening 1325 of shell 1320. For example, spring contacts 1340a-1340d may be positioned within opening 1325 such that its distance from first and second inner surfaces 1320a, 1320b causes spring contacts 1340a-1340d to always deflect, possibly with the assistance of bullnose tips, toward the appropriate region within a corresponding receptacle connector regardless of whether plug connector 1310 is in the first or second orientation, as described above.

Body 1315 is generally the portion of connector 10 that a user will hold onto when inserting or removing connector 1310 from a corresponding receptacle connector. Body 1315 can be made out of a variety of materials and in some embodiments is made from a dielectric material, such as a thermoplastic polymer formed in an injection molding process. While not shown in FIG. 13A or 13B, a cable and a portion of shell 1320 may extend within and be enclosed by body 1315. Also, electrical contact to spring contacts 1340a-1340d can be made with individual wires in a cable within body 1315. In one embodiment, a cable includes a plurality of individual insulated wires for connecting to spring contacts 1340a-1340d that are soldered to bonding pads on a PCB housed within body 1315. Thus, the bonding pads on the PCB may be electrically coupled to corresponding individual spring contacts 1340a-1340d.

Spring contacts 1340a-1340d can be made from copper, nickel, brass, a metal alloy or any other appropriate conductive material. As with standard USB plug connectors, plug connector 1310 may include contacts for power, ground and a pair of differential data signals (e.g., data transmit). For example, contact 1340a may be a ground pin, contact 1340b may be a Data+pin, contact 1340c may be a Data−pin, and contact 1340d may be a power pin (VBUS).

A sensing circuit as described above may be included with connector 1310 and/or a corresponding receptacle connector.

An example of another embodiment of the present invention is shown in the following figures.

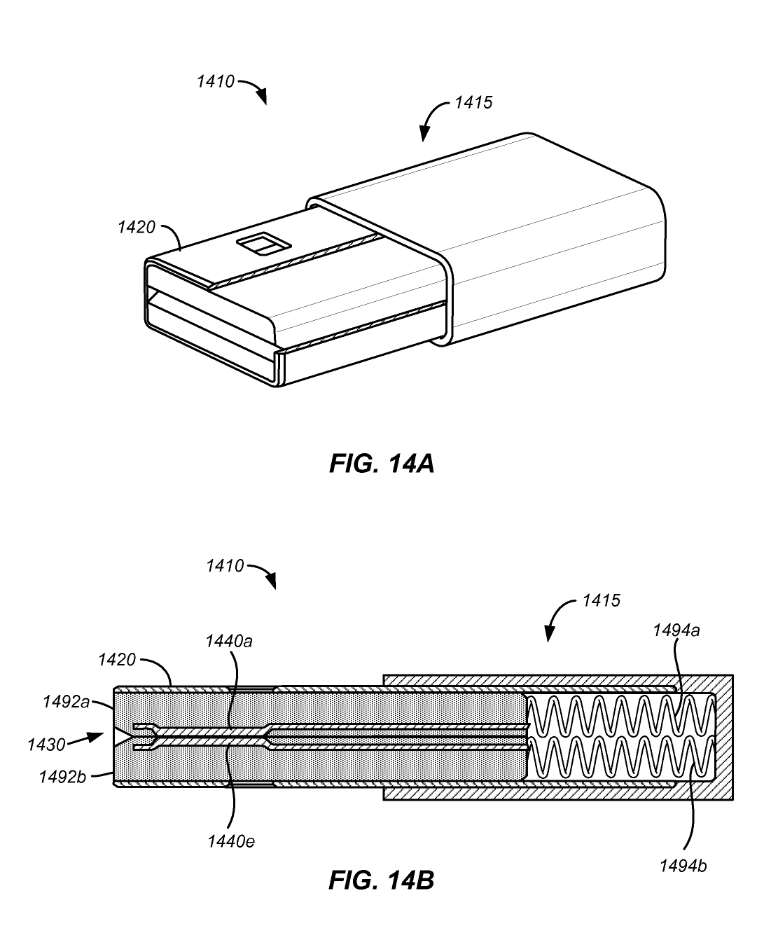

FIGS. 14A and 14B are partial cross sectional perspective and cross sectional views, respectively, of a USB plug connector 1410 according to one embodiment of the present invention. Connector 1410 includes a body 1415 and a shell 1420 extending longitudinally away from body 1415 in a direction parallel to the length of connector 1410. Shell 1420 contains a first and second pistoning contact blocks 1492a, 1492b. Springs 1494a and 1494b may bias pistoning blocks 1492a and 1492b, respectively, in the position shown in FIG. 4B. When a pistoning contact blocks 1492a and/or 1492b are pressed into shell 1420 (e.g., during a mating event with a receptacle connector corresponding to plug connector 1410), springs 1494a and/or 1494b may compress in order to allow this movement. And when a pressing force is removed from pistoning contact blocks 1492a and/or 1492b, springs 1494a and/or 1494b may cause pistoning contact blocks 1492a and/or 1492b to return to their positions as shown in FIG. 14B. Additionally, when one of pistoning blocks 1492a, 1492b is pressed into shell 1420, a tongue 1430 may be revealed. Tongue 1430 may be centrally located within shell 1420 and extend parallel to the length of connector 1410. Four contacts (e.g., contacts 1440a and 1440e as shown in FIG. 14B) may be disposed on both of first and second major surfaces of tongue 1430.

As shown in FIGS. 14A and 14B, connector 1410 can have a 180 degree symmetrical, double orientation design which enables the connector to be inserted into a corresponding receptacle connector in both a first orientation as shown in FIG. 14A and a second orientation where connector 1410 is rotated 180 degrees about its length axis. Specifics of general double or dual orientation designs are discussed in greater detail above. Simply stated, the dual orientation design of connector 1410 allows one set of four contacts of 1410 to mate with contacts of the corresponding receptacle connector in the first and in the second orientation.

Tongue 1430 may be any of the tongue embodiments previously described herein. However, a rigid embodiment of tongues according to the present invention may be useful for connector 1410. The contacts of tongue 1430 may also be any of the contacts embodiments previously described herein.

Body 1415 is generally the portion of connector 1410 that a user will hold onto when inserting or removing connector 1410 from a corresponding receptacle connector. Body 1415 can be made out of a variety of materials and in some embodiments is made from a dielectric material, such as a thermoplastic polymer formed in an injection molding process. While not shown in FIG. 14A or 14B, a cable and a portion of shell 1420 may extend within and be enclosed by body 1415, as described in relation to other embodiments of the present invention.

A sensing circuit as described above may be included with connector 1410 and/or a corresponding receptacle connector.

Also, while a number of specific embodiments were disclosed with specific features, a person of skill in the art will recognize instances where the features of one embodiment can be combined with the features of another embodiment. For example, some specific embodiments of the invention set forth above were illustrated with specific tongue or tab designs. A person of skill in the art will readily appreciate that any of the tongues or tab described herein, as well as others not specifically mentioned, may be used instead of or in addition to the tongue or tab discussed with respect to specific embodiments of the present invention. As another example, some specific embodiments of the invention set forth above were illustrated with cable assemblies having a cable connected to a USB connector. A person of skill in the art will readily appreciate that any of the cable assemblies herein, as well as others not specifically mentioned, may be modified to be a USB flash drive or another device that includes a USB connector but does not include a cable. Also, those skilled in the art will recognize, or be able to ascertain using no more than routine experimentation, many equivalents to the specific embodiments of the inventions described herein.

What is claimed is:

1. A reversible Universal Serial Bus plug connector comprising:
a body;
a dielectric base;
a shell extending from the body and having an opening at a first end that communicates with a cavity defined by four inner surfaces of the shell and the dielectric base;
a deflectable tongue disposed within the cavity and extending from the dielectric base towards the opening, the tongue having a tip proximal the opening and first and second opposing surfaces that extend from the tip towards the base and including:
a first plurality of contacts exposed at the first surface of the tongue proximal the tip, the first plurality of contacts including first, second, third and fourth contacts;
a second plurality of contacts exposed at the second surface of the tongue, the second plurality of contacts including a fifth contact directly opposite the first contact, a sixth contact directly opposite the second contact, a seventh contact directly opposite the third contact, and an eighth contact directly opposite the fourth contact;
a dielectric spacer formed around and between the first and second plurality of contacts to electrically isolate each contact from adjacent contacts;
a first plurality of electrically conductive contact frames including a first contact frame coupled to the first contact, a second contact frame coupled to the second contact, a third contact frame coupled to the third contact, a fourth contact frame coupled to the fourth contact, a fifth contact frame coupled to the fifth contact, and an eighth contact frame coupled to the eighth contact, each of the first plurality of contact frames extending from its respective contact into the dielectric base; and
a second plurality of electrically conductive contact frames including a sixth contact frame coupled to the sixth contact and a seventh contact frame coupled to the seventh contact;
wherein the first and eighth contact frames are electrically coupled, the fourth and fifth contact frames are electrically coupled, the second and seventh contact frames are electrically coupled, and the third and sixth contact frames are electrically coupled; and wherein an arm extends between the sixth and seventh contact frames.

2. The plug connector set forth in claim 1 wherein the tip is overmolded over the first and second plurality of electrically conductive contact frames.

3. The plug connector set forth in claim 1 wherein the first and eighth contact frames, the fourth and fifth contact frames, the second and seventh contact frames, and the third and sixth contact frames are electrically coupled using laser welds.

4. The plug connector set forth in claim 1 wherein the first and second plurality of contact frames are made from a copper-titanium alloy.

5. The plug connector set forth in claim 1 wherein the first and second plurality of contacts include ground, power, data+ and data−contacts.

6. The plug connector set forth in claim 1 wherein each of the first through eighth contacts are raised portions punched from their respective contact frame.

7. The plug connector set forth in claim 1 wherein each of the first through eighth contacts are contact pucks soldered to their respective contact frame.

8. A Universal Serial Bus plug connector comprising:
a body;
a base housed in the body;
a cable coupled to the body and including a plurality of insulated wires, including a ground wire, a data+wire, a data−wire and a power wire; and
a tab extending longitudinally away from base in a direction parallel to the length of the plug connector, the tab including a plurality of contact frames, each contact frame including a first contact exposed at a top surface of the tab and a second contact exposed a bottom surface of the tab, wherein each contact frame is electrically coupled with a different wire of the plurality of insulated wires, wherein the plurality of contact frames are shaped and sized to provide the same Universal Serial Bus pinout on both the first and second sides of the tab,
wherein the tab is shaped and the first and second plurality of contacts are positioned on the tab to have 180 degree symmetry such that the plug connector can be inserted and operatively coupled to a corresponding receptacle connector in either of two orientations.

9. The plug connector set forth in claim 8 wherein each contact frame of the plurality of contact frames is electrically coupled with a different wire via a printed circuit board at which the plurality of contact frames and insulated wires are terminated, thereby allowing the printed circuit board to appropriately route signals between the insulated wires and the contacts of the plurality of contact frames.

10. The plug connector set forth in claim 8 wherein the plurality of contact frames are made from copper using a metal stamping operation.

11. The plug connector set forth in claim 8 wherein a contract frame of the plurality of contact frames includes an insulative spacer.

12. The plug connector set forth in claim 8 wherein the body is made from a thermoplastic polymer.

13. The plug connector set forth in claim 8 further comprising a structural support assembled with the base.

14. The plug connector set forth in claim 8 wherein the tab does not include a polarization key and can be inserted and operatively coupled to a corresponding receptacle connector in either of two orientations.

15. A Universal Serial Bus plug connector comprising:
a body;
a cable coupled to the body and including a plurality of insulated wires;
a shell extending from the body and having an opening that communicates with a cavity defined by four inner surfaces of the shell and a support structure housed in the shell, the cavity having 180 degree symmetry; and
a tongue disposed within the opening of the shell and extending from the support structure and toward the opening, the tongue further defining the cavity, the tongue including a printed circuit board having top and bottom surfaces, the top and bottoms surfaces each including four contacts arranged according to a Universal Serial Bus pinout,
wherein the tongue is shaped and the contacts on the top and bottom surfaces are positioned on the tongue to have 180 degree symmetry such that the plug connector can be inserted and operatively coupled to a corresponding receptacle connector in either of two orientations.

16. The plug connector set forth in claim 15 further comprising a sensing circuit configured to detect which of the top and bottom surfaces are in contact with contacts of a corresponding receptacle connector.

17. The plug connector set forth in claim 16 wherein the printed circuit board is configured to routes signals between the insulated wires and the contacts of the tongue using input received from the sensing circuit.

18. The plug connector set forth in claim 15 wherein the tongue further includes an overmold formed around the printed circuit board, wherein the overmold includes openings for each of the contacts on the front and back surfaces of the printed circuit board.

19. The plug connector set forth in claim 15 wherein the four contacts of the top and bottom surfaces include ground, power, data+ and data−.

20. The plug connector set forth in claim 15 wherein the tongue includes a bullnose tip at its distal end.
